(19) United States
(12) Patent Application Publication
(10) Pub. No.: US 2022/0389258 A1
(43) Pub. Date: Dec. 8, 2022

(54) CLEAR INK, PRINTING METHOD, AND INKJET PRINTING APPARATUS

(71) Applicants: Hiroaki TAKAHASHI, Kanagawa (JP); Akiko Bannai, Kanagawa (JP); Kiminori Masuda, Tokyo (JP); Yukiko Takamura, Kanagawa (JP)

(72) Inventors: Hiroaki TAKAHASHI, Kanagawa (JP); Akiko Bannai, Kanagawa (JP); Kiminori Masuda, Tokyo (JP); Yukiko Takamura, Kanagawa (JP)

(73) Assignee: Ricoh Company, Ltd., Tokyo (JP)

(21) Appl. No.: 17/755,052

(22) PCT Filed: Dec. 2, 2020
(86) PCT No.: PCT/JP2020/044758

§ 371 Date: Apr. 20, 2022

(30) Foreign Application Priority Data
Dec. 13, 2019 (JP) 2019-225069
Mar. 4, 2020 (JP) 2020-036555

(51) Int. Cl. C09D 11/54; C09D 11/32; C09D 11/38; C09D 11/102

(52) U.S. Cl. CPC C09D 11/54; C09D 11/32; C09D 11/38; C09D 11/102; B82Y 30/00

(57) ABSTRACT

A clear ink includes resin particles and water, wherein a volume average particle diameter of the resin particles is 50 nm or less, and wherein a dried film of the clear ink has glass transition temperatures (Tg) at 50 degrees C. or higher and at lower than 0 degrees C.

### TECHNICAL FIELD

The present disclosure relates to a clear ink, a printing method, and an inkjet printing apparatus.

### BACKGROUND ART

Impermeable recording media such as plastic films are used for commercial applications such as advertisement and signage and packaging materials for foods, beverages, and daily necessities in order to improve durabilities such as light resistance, water resistance, and wear resistance. Various inks to be used on such impermeable recording media have been developed.

As such inks, for example, solvent-based inks using an organic solvent as a solvent and ultraviolet-ray-curable inks containing a polymerizable monomer as a main component are widely used. However, solvent-based inks are feared to be environmentally hazardous through evaporation of the organic solvent, and ultravioletray-curable inks may be limited in the options of polymerizable monomers to be used in terms of safety.

Hence, ink sets including water-based inks that have a low environmental impact and can be directly recorded over impermeable recording media have been proposed.

Problems of such water-based inks that can be directly recorded over impermeable recording media include scratch resistance, and methods for improving scratch resistance have been proposed.

For example, a disclosed water-based ink contains water, a water-soluble organic solvent, pigment-containing vinyl polymer particles, and polycarbonate-based urethane resin particles, wherein the water-soluble organic solvent contains only a water-soluble organic solvent having a boiling point of 250 degrees C. or lower (for example, see PTL 1).

A disclosed method forms a water-based latex ink protective layer over a dried water-based latex color image layer, using a water-based latex ink containing water or a hydrophilic organic solvent and a resin, the resin being emulsified or suspended in the water or the hydrophilic organic solvent (for example, see PTL 2).

### CITATION LIST

### Patent Literature

PTL 1: Japanese Unexamined Patent Application Publication No. 2015-147919
PTL 2: Japanese Unexamined Patent Application Publication No. 2013-212644

### SUMMARY OF INVENTION

### Technical Problem

The present disclosure has an object to provide a clear ink that can form a coating film having an excellent scratch resistance.

### Solution to Problem

According to one aspect of the present disclosure, a clear ink contains resin particles and water. The volume average particle diameter of the resin particles is 50 nm or less. A dried film of the clear ink has glass transition temperatures (Tg) at 50 degrees C. or higher and at lower than 0 degrees C.

### Advantageous Effects of Invention

The present disclosure can provide a clear ink that can form a coating film having an excellent scratch resistance.

### BRIEF DESCRIPTION OF DRAWINGS

FIG. 1 is a perspective view exemplarily illustrating an example of a recording apparatus of the present disclosure.

FIG. 2 is a perspective view exemplarily illustrating an example of a main tank of the present disclosure.

FIG. 3 is an outer perspective view illustrating an example of an ink discharging head of an inkjet printing apparatus of the present disclosure.

FIG. 4 is a cross-sectional view of an ink discharging head of an inkjet printing apparatus of the present disclosure taken in a direction orthogonal to a direction in which nozzles are arranged.

FIG. 5 is a partial cross-sectional view of an ink discharging head of an inkjet printing apparatus of the present disclosure taken in a direction parallel with a direction in which nozzles are arranged.

FIG. 6 is a plan view of a nozzle plate of an ink discharging head of an inkjet printing apparatus of the present disclosure.

FIG. 7A is a plan view of each member constituting a flow path member of an ink discharging head of an inkjet printing apparatus of the present disclosure.

FIG. 7B is a plan view of each member constituting a flow path member of an ink discharging head of an inkjet printing apparatus of the present disclosure.

FIG. 7C is a plan view of each member constituting a flow path member of an ink discharging head of an inkjet printing apparatus of the present disclosure.

FIG. 7D is a plan view of each member constituting a flow path member of an ink discharging head of an inkjet printing apparatus of the present disclosure.

FIG. 7E is a plan view of each member constituting a flow path member of an ink discharging head of an inkjet printing apparatus of the present disclosure.

FIG. 7F is a plan view of each member constituting a flow path member of an ink discharging head of an inkjet printing apparatus of the present disclosure.

FIG. 8A is a plan view of each member constituting a common liquid chamber member of an ink discharging head of an inkjet printing apparatus of the present disclosure.

FIG. 8B is a plan view of each member constituting a common liquid chamber member of an ink discharging head of an inkjet printing apparatus of the present disclosure.

FIG. 9 is a block diagram illustrating an example of a liquid circulation system of the present disclosure.

FIG. 10 is a cross-sectional view taken along a line A-A′ of FIG. 4.

FIG. 11 is a cross-sectional view taken along a line B-B′ of FIG. 4.

FIG. 12 is a main part plan view illustrating an example of an inkjet printing apparatus of the present disclosure.

FIG. 13 is a main part side view of an inkjet printing apparatus of the present disclosure.

FIG. 14 is a main part plan view of another example of an ink discharging unit of an inkjet printing apparatus of the present disclosure.

### DESCRIPTION OF EMBODIMENTS

(Clear ink)

A clear ink of the present disclosure is a clear ink containing resin particles and water. The volume average particle diameter of the resin particles is 50 nm or less. A dried film of the clear ink has glass transition temperatures (Tg) at 50 degrees C. or higher and at lower than 0 degrees C.

The clear ink of the present disclosure is based on a finding that existing inks are taken care of to have a better scratch resistance, but may not be ensured a sufficient scratch resistance against various hazards in actual use.

According to existing techniques, the amount of resins to be contained in inks becomes necessarily high in order to improve scratch resistance. Therefore, inks may abruptly thicken or viscoelastic characteristics of inks may change due to drying. Hence, a sufficient discharging reliability may not be ensured.

As a result of conducting earnest studies into clear inks that can form coating films having an excellent scratch resistance, the present inventors have found that a coating film having an excellent scratch resistance can be formed with a clear ink containing resin particles and water, wherein the volume average particle diameter of the resin particles is 50 nm or less, and wherein a dried film of the clear ink has glass transition temperatures (Tg) at 50 degrees C. or higher and at lower than 0 degrees C.

The clear ink of the present disclosure contains resin particles and water.

A clear ink means a colorless, transparent ink substantially free of a colorant. Substantially free of a colorant means that the content of a colorant in the clear ink is 0.5% by mass or less. The clear ink may contain a colorant so long as the content of the colorant is of an impurity level.

A water-based clear ink means a clear ink containing water as a solvent. The waterbased clear ink may contain an organic solvent as needed.

The clear ink contains at least resin particles and water, preferably contains a surfactant, and further contains other components as needed.

<Resin Particles>

The kind of the resin of the resin particles contained in the clear ink is not particularly limited and may be appropriately selected depending on the intended purpose. Examples of the resin include polyurethane resins, polyester resins, acrylic resins, vinyl acetate-based resins, styrene resins, butadiene resins, styrene-butadiene resins, vinyl chloride resins, acrylic-styrene resins, and acrylic-silicone resins. In production of the ink, the resin is added in the form of resin particles made of the resin. The resin particles may be added in the ink in the form of a resin emulsion dispersed in water serving as a dispersion medium. As the resin particles, an appropriately synthesized product may be used or a commercially available product may be used. One of these kinds of resin particles may be used alone or two or more of these kinds of resin particles may be used in combination.

The volume average particle diameter of the resin particles is 50 nm or less, and preferably 10 nm or greater but 40 nm or less. When the volume average particle diameter of the resin particles is 50 nm or less, a uniform clear ink coating film can be formed. The lower limit of the volume average particle diameter of the resin particles is approximately 5 nm.

The volume average particle diameter of the resin particles can be measured with, for example, a particle size analyzer (NANOTRAC WAVE II, available from MicrotracBEL Corporation).

A dried film of the clear ink has glass transition temperatures (Tg) at 50 degrees C. or higher and at lower than 0 degrees C., preferably at 50 degrees C. or higher but lower than 100 degrees C. and at −50 degrees C. or higher but lower than 0 degrees C. When a dried film of the clear ink has Tg at 50 degrees C. or higher and at lower than 0 degrees C., a clear ink coating film has a better scratch resistance.

The resin particles contain at least two kinds of resin particles, namely resin particles A and resin particles B. It is preferable that Tg of the resin particles A be 50 degrees C. or higher, and that Tg of the resin particles B be lower than 0 degrees C. It is more preferable that Tg of the resin particles A be 50 degrees C. or higher but lower than 100 degrees C., and that Tg of the resin particles B be −50 degrees C. or higher but lower than 0 degrees C. When the resin particles contain the resin particles A having Tg at 50 degrees C. or higher, a clear ink coating film has stiffness and an improved scratch resistance. When the resin particles further contain the resin particles B having Tg at lower than 0 degrees C., the clear ink has an improved close adhesiveness with a foundation. As a result, a clear ink coating film has an improved scratch resistance.

In terms of satisfying both of scratch resistance and close adhesiveness at the same time, a mass ratio MA:MB between the mass MA of the resin particles A and the mass MB of the resin particles B is from 98:2 through 80:20. It is preferable that the resin particles A having Tg at 50 degrees C. or higher be contained in a greater amount. More preferably, the resin particles A are polyurethane resin particles.

Tg of a dried film of the clear ink and the resin particles can be measured with, for example, differential scanning calorimeters (TA-60WS and DSC-60, available from Shimadzu Corporation).

-Polyurethane Resin-

When a polyurethane resin is added in the clear ink, an ink coating film formed with the clear ink has stiffness. This is preferable because this makes it easier to suppress internal breakage of the coating film and consequent partial peeling of the coating film, or change of the surface condition of the coating film and consequent change of the hue of a rubbed portion.

Examples of the polyurethane resin include polyether-based polyurethane resins, polycarbonate-based polyurethane resins, and polyester-based polyurethane resins.

The polyurethane resin is not particularly limited and may be appropriately selected depending on the intended purpose. Examples of the polyurethane resin include polyurethane resins obtained by allowing polyol to undergo reaction with polyisocyanate.

-Polyol-

Examples of the polyol include polyether polyol, polycarbonate polyol, and polyester polyol. One of these polyols may be used alone or two or more of these polyols may be used in combination.

-Polyether Polyol-

Examples of the polyether polyol include a product obtained by allowing alkylene oxide to undergo addition polymerization with a starting material, which is at least one selected from compounds containing two or more active hydrogen atoms.

Examples of the compounds containing two or more active hydrogen atoms include ethylene glycol, diethylene glycol, triethylene glycol, propylene glycol, trimethylene glycol, 1,3-butanediol, 1,4-butanediol, 1,6-hexanediol, glycerin, trimethylolethane, and trimethylolpropane. One of these compounds may be used alone or two or more of these compounds may be used in combination.

Examples of the alkylene oxide include ethylene oxide, propylene oxide, butylene oxide, styrene oxide, epichlorohydrin, and tetrahydrofuran. One of these alkylene oxides may be used alone or two or more of these alkylene oxides may be used in combination.

The polyether polyol is not particularly limited and may be appropriately selected depending on the intended purpose. Polyoxytetramethylene glycol and polyoxypropylene glycol are preferable in terms of obtaining a binder for an ink capable of imparting an exceptional scratch resistance. One of these polyether polyols may be used alone or two or more of these polyether polyols may be used in combination.

-Polycarbonate Polyol-

Examples of the polycarbonate polyol that can be used for producing the polyurethane resin include products obtained by allowing carbonic acid ester to undergo reaction with polyol, and products obtained by allowing phosgene to undergo reaction with, for example, bisphenol A. One of these polycarbonate polyols may be used alone or two or more of these polycarbonate polyols may be used in combination.

Examples of the carbonic acid ester include methyl carbonate, dimethyl carbonate, ethyl carbonate, diethyl carbonate, cyclocarbonate, and diphenyl carbonate. One of these carbonic acid esters may be used alone or two or more of these carbonic acid esters may be used in combination.

Examples of the polyol include: dihydroxy compounds having a relatively low molecular weight such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, 1,8-octanediol, 1,9-nonanediol, 1,10-decanediol, 1,11-undecanediol, 1,12-dodecanediol, 1,4-cyclohexanediol, 1,4-cyclohexanedimethanol, hydroquinone, resorcin, bisphenol A, bisphenol-F, and 4,4′-biphenol; and polyether polyols such as polyethylene glycol, polypropylene glycol, and polyoxytetramethylene glycol; and polyester polyols such as polyhexamethylene adipate, polyhexamethylene succinate, and polycaprolactone. One of these polyols may be used alone or two or more of these polyols may be used in combination.

-Polyester Polyol-

Examples of the polyester polyol include products obtained by allowing polyol having a low molecular weight to undergo esterification reaction with polycarboxylic acid, polyesters obtained by allowing a cyclic ester compound such as ε-caprolactone to undergo ring-opening polymerization reaction, and copolyester of these polyesters. One of these polyester polyols may be used alone or two or more of these polyester polyols may be used in combination.

Examples of the polyol having a low molecular weight include ethylene glycol and propylene glycol. One of these polyols may be used alone or two or more of these polyols may be used in combination.

Examples of the polycarboxylic acid include succinic acid, adipic acid, sebacic acid, dodecanedicarboxylic acid, terephthalic acid, isophthalic acid, phthalic acid, and anhydrides or ester-forming derivatives of these polycarboxylic acids. One of these polycarboxylic acids may be used alone or two or more of these polycarboxylic acids may be used in combination.

-Polyisocyanate-

Examples of the polyisocyanate include: aromatic diisocyanates such as phenylene diisocyanate, tolylene diisocyanate, diphenylmethane diisocyanate, and naphthalene diisocyanate; aliphatic or alicyclic diisocyanates such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, 2,2,4-trimethylhexamethylene diisocyanate. One of these polyisocyanates may be used alone or two or more of these polyisocyanates may be used in combination. Among these polyisocyanates, alicyclic diisocyanates are preferable in terms of weather resistance.

Additional use of at least one kind of an alicyclic diisocyanate makes it easier to obtain an intended coating film strength and an intended scratch resistance.

Examples of the alicyclic diisocyanate include isophorone diisocyanate and dicyclohexylmethane diisocyanate.

The content of the alicyclic diisocyanate is preferably 60% by mass or greater relative to the total amount of the isocyanate compound.

<Method for Producing Polyurethane Resin>

The method for producing the polyurethane resin is not particularly limited. The polyurethane resin can be obtained by producing methods that have been hitherto commonly used. Examples of the producing method include the following methods. First, in the absence of a solvent or in the presence of an organic solvent, the polyol and the polyisocyanate are allowed to undergo reaction at an equivalent ratio at which isocyanate groups will be excessive, to produce an isocyanate-terminated urethane prepolymer.

Next, anionic groups in the isocyanate-terminated urethane prepolymer are neutralized with a neutralizer as needed, and subsequently allowed to undergo reaction with a chain extender. Finally, the organic solvent in the system is removed as needed. In this way, the polyurethane resin can be obtained.

Examples of the organic solvent that can be used for producing the polyurethane resin include: ketones such as acetone, and methyl ethyl ketone; ethers such as tetrahydrofuran, and dioxane; acetic acid esters such as ethyl acetate and butyl acetate; nitriles such as acetonitrile; and amides such as dimethylformamide, N-methyl pyrrolidone, and N-ethyl pyrrolidone. One of these organic solvents may be used alone or two or more of these organic solvents may be used in combination.

Examples of the chain extender include polyamines and other active hydrogen groupcontaining compounds.

Examples of the polyamine include: diamines such as ethylene diamine, 1,2-propane diamine, 1,6-hexamethylene diamine, piperazine, 2,5-dimethyl piperazine, isophorone diamine, 4,4′-dicyclohexylmethane diamine, and 1,4-cyclohexane diamine; polyamines such as diethylene triamine, dipropylene triamine, and triethylene tetramine; hydrazines such as hydrazine, N,N′-dimethyl hydrazine, and 1,6-hexamethylene bishydrazine; dihydrazides such as succinic acid dihydrazide, adipic acid dihydrazide, glutaric acid dihydrazide, sebacic acid dihydrazide, and isophthalic acid dihydrazide. One of these polyamines may be used alone or two or more of these polyamines may be used in combination.

Examples of the other active hydrogen group-containing compounds include: glycols such as ethylene glycol, diethylene glycol, triethylene glycol, propylene glycol, 1,3-propanediol, 1,3-butanediol 1,4-butanediol, hexamethylene glycol, saccharose, methylene glycol, glycerin, and sorbitol; phenols such as bisphenol A, 4,4′-dihydroxydiphenyl, 4,4′-dihydroxydiphenyl ether, 4,4′-dihydroxydiphenyl sulfone, hydrogenated bisphenol A, and hydroquinone; and water. One of these other active hydrogen group-containing compounds may be used alone or two or more of these other active hydrogen group-containing compounds may be used in combination so long as storage stability of the ink is not degraded.

Polycarbonate-based polyurethane resins are preferable as the polyurethane resin in terms of water resistance, heat resistance, wear resistance, weather resistance, and image scratch resistance based on a high cohesive force of carbonate groups. With the polycarbonate-based polyurethane resins, an ink suitable for printed matters to be used under severe conditions such as outdoors can be obtained.

A commercially available product may be used as the polyurethane resin. Examples of the commercially available product include UCOAT UX-485 (polycarbonate-based polyurethane resin), UCOAT UWS-145 (polyester-based polyurethane resin), PERMARINE UA-368T (polycarbonate-based polyurethane resin), and PERMARINE UA-200 (polyether-based polyurethane resin) (all available from Sanyo Chemical Industries, Ltd.). One of these commercially available products may be used alone or two or more of these commercially available products may be used in combination.

A total content of the resin particles contained in the clear ink is preferably 10% by mass or greater, and in terms of an excellent scratch resistance and an excellent ink discharging stability, more preferably 10% by mass or greater but 25% by mass or less. When the total content of the resin particles is 10% by mass or greater, a scratch resistance is better improved.

<Water>

The water is not particularly limited and may be appropriately selected depending on the intended purpose. Examples of the water include pure water such as ion-exchanged water, ultrafiltrated water, reverse osmotic water, and distilled water, and ultrapure water. One of these kinds of water may be used alone or two or more of these kinds of water may be used in combination.

The content of the water is preferably 15% by mass or greater but 60% by mass or less relative to the total amount of the clear ink. When the content of the water is 15% by mass or greater, thickening to a high viscosity can be prevented and discharging stability can be improved. On the other hand, when the content of the water is 60% by mass or less, a good wettability over impermeable recording media can be obtained and image quality can be improved.

<Surfactant>

It is preferable that the clear ink contain a surfactant.

When a surfactant is added in the ink, the surface tension of the ink is reduced, and the ink permeates recording media such as paper quickly after ink droplets land on the recording media. Therefore, feathering and color bleed can be reduced.

Surfactants are classified into nonionic, anionic, and amphoteric surfactants depending on the polarity of the hydrophilic group.

Surfactants are classified into fluorine-based, silicone-based, and acetylene-based surfactants depending on the structure of the hydrophobic group.

In the present disclosure, fluorine-based surfactants are mainly used. However, silicone-based surfactants and acetylene-based surfactants may be used in combination.

As the surfactant, any of silicone-based surfactants, fluorine-based surfactants, amphoteric surfactants, nonionic surfactants, and anionic surfactants may be used.

The silicone-based surfactant has no specific limit and can be suitably selected to suit to a particular application. Among silicone-based surfactants, preferred are siliconebased surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because these fluoro surfactants do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂ CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMULSION Co., Ltd., Kyoeisha Chemical Co., Ltd., etc.

The polyether-modified silicone-based surfactant has no particular limit and can be suitably selected to suit to a particular application. Examples thereof include a compound in which the polyalkylene oxide structure represented by the following General formula (S-1) is introduced into the side chain of the Si site of dimethyl polysiloxane.

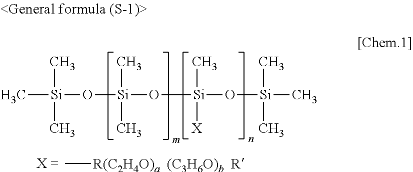

In General formula S-1, “m”, “n”, “a”, and “b” each, respectively represent integers, R represents an alkylene group, and R′ represents an alkyl group.

Products available on the market may be used as the polyether-modified siliconebased surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.).

A fluorosurfactant in which the number of carbon atoms replaced with fluorine atoms is from 2 to 16 and more preferably from 4 to 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these fluorosurfactants, polyoxyalkylene ether polymer compounds having a perfluoroalkyl ether group in its side chain are preferable because these compounds do not foam easily and the fluorosurfactant represented by the following General formula F-1 or General formula F-2 is particularly preferable.

<General Formula (F-1)>

CF₃CF₂(CF₂CF₂)ₘ—CH₂CH₂O(CH₂CH₂O)ₙH [Chem.2]

In the General formula (F-1), “m” is preferably 0 or an integer of from 1 to 10 and “n” is preferably 0 or an integer of from 1 to 40 in order to provide water solubility.

CₙF₂ₙ₊₁—CH₂CH(OH)CH₂—O—(CH₂CH₂O)ₐ—Y <General formula (F-2)>

In the General formula F-2, Y represents H, CₘF₂ₘ₊₁, where “m” is an integer of from 1 to 6, CH₂CH(OH)CH₂—CₘF₂ₘ₊₁, where m represents an integer of from 4 to 6, or Cₚ H₂ₚ₊₁, where p represents an integer of from 1 to 19. “n” represents an integer of from 1 to 6. “a” represents an integer of from 4 to 14.

Products available on the market may be used as the fluorosurfactant.

Specific examples of the products available on the market include, but are not limited to, SURFLON S-111, S-112, S-113, S-121, S-131, S-132, S-141, and S-145 (all available from ASAHI GLASS CO., LTD.); FLUORAD FC-93, FC-95, FC-98, FC-129, FC-135, FC-170C, FC-430, and FC-431 (all available from SUMITOMO 3M); MEGAFAC F-470, F-1405, and F-474 (all available from DIC Corporation); ZONYL TBS, FSP, FSA, FSN-100, FSN, FSO-100, FSO, FS-300, and UR, and CAPSTONE (registered trademark) FS-30, FS-31, FS-3100, FS-34, and FS-35 (all available from the Chemours Company); FT-110, FT-250, FT-251, FT-4005, FT-150, and FT-400SW (all available from NEOS COMPANY LIMITED), POLYFOX PF-136A,PF-156A, PF-151N, PF-154, and PF-159 (available from OMNOVA SOLUTIONS INC.), and UNIDYNE DSN-403N (available from DAIKIN INDUSTRIES). Of these products, FS-3100, FS-34, and FS-300 available from the Chemours Company, FT-110, FT-250, FT-251, FT-4005, FT-150, and FT-400SW all available from NEOS COMPANY LIMITED, POLYFOX PF-151N available from OMNOVA SOLUTIONS INC., and UNIDYNE DSN-403N available from DAIKIN INDUSTRIES are particularly preferable in terms of good printing quality, coloring in particular, and improvement on permeation, wettability, and uniform dyeing property to paper.

<Organic Solvent>

The clear ink may contain an organic solvent. The organic solvent is not particularly limited and may be appropriately selected depending on the intended purpose. Examples of the organic solvent include water-soluble organic solvents. Water solubility means, for example, solubility of 5 g or greater in 100 g of water at 25 degrees C.

Examples of the water-soluble organic solvent include: polyvalent alcohols such as ethylene glycol, diethylene glycol, 1,2-propanediol, 1,3-propanediol, 1,2-butanediol, 1,3-butanediol, 2,3-butanediol, 3-methyl-1,3-butanediol, 3-methoxy-3-methyl butanol, triethylene glycol, polyethylene glycol, polypropylene glycol, 1,5-pentanediol, 2-methyl-2,4-pentanediol, 1,6-hexanediol, glycerin, 1,2,6-hexanetriol, 2-ethyl-1,3-hexanediol, ethyl 1,2,4-butanetriol, 1,2,3-butanetriol, and petriol; polyvalent alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether, and dipropylene glycol monomethyl ether; polyvalent alcohol aryl ethers such as ethylene glycol monophenyl ether, and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl imidazolidinone, ε-caprolactam, and γ-butyrolactone; amides such as formamide, Nmethyl formamide, and N,N-dimethyl formamide; amines such as monoethanol amine, diethanol amine, and triethyl amine; sulfur-containing compounds such as dimethyl sulfoxide, sulfolane, and thiodiethanol; and propylene carbonate, and ethylene carbonate. One of these water-soluble organic solvents may be used alone or two or more of these water-soluble organic solvents may be used in combination.

The content of the organic solvent in the clear ink is not particularly limited, may be appropriately selected depending on the intended purpose, and is preferably 10% by mass or greater but 60% by mass or less and more preferably 20% by mass or greater but 60% by mass or less in terms of drying property and discharging reliability of the ink.

The clear ink may contain a defoaming agent, a preservative and fungicide, a corrosion inhibitor, and a pH regulator as other components as needed.

-Defoaming Agent-

The defoaming agent has no particular limit. For example, silicone-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

-Preservative and Fungicide-

The preservatives and fungicides are not particularly limited. A specific example is 1,2-benzisothiazolin-3-on.

-Corrosion Inhibitor-

The corrosion inhibitor has no particular limit. Examples thereof are acid sulfite and sodium thiosulfate.

-pH Regulator-

The pH regulator has no particular limit. It is preferable to adjust the pH to 7 or higher. Specific examples thereof include, but are not limited to, amines such as diethanol amine and triethanol amine.

The property of the clear ink is not particularly limited and can be suitably selected to suit to a particular application. For example, viscosity, surface tension, pH, etc., are preferably in the following ranges.

The viscosity of the clear ink at 25 degrees C. is preferably from 5 to 30 mPa s and more preferably from 5 to 25 mPa s to improve print density and text quality and obtain good dischargeability. The viscosity can be measured by, for example, a rotatory viscometer (RE-80L, manufactured by TOKI SANGYO CO., LTD.). The measuring conditions are as follows:

-Standard cone rotor (1° 34′×R24)

-Sample liquid amount: 1.2 mL

-Number of rotations: 50 rotations per minute (rpm)

−25 degrees C.

-Measuring time: three minutes

The surface tension of the clear ink is preferably 35 mN/m or less and more preferably 32 mN/m or less at 25 degrees C. in terms that the clear ink is suitably levelized on a print medium and the drying time of the clear ink is shortened.

The pH of the clear ink is preferably from 7 to 12 and more preferably from 8 to 11 in terms of prevention of corrosion of metal materials contacting the ink.

<Print Target>

A print target is not limited to articles used as typical print media. It is suitable to use building materials such as wall paper, floor material, and tiles, cloth for apparel such as T-shirts, textile, and leather as the print medium. In addition, the configuration of the paths through which the print medium is transferred can be adjusted to accommodate ceramics, glass, metal, etc. as the print target.

The print medium for use in printing is not particularly limited. Plain paper, gloss paper, special paper, cloth, etc. are usable. Also, good images can be formed on a nonpermeating substrate.

The non-permeating substrate has a surface with low moisture permeability and absorbency and includes a material having myriad of hollow spaces inside but not open to the outside. To be more quantitative, the substrate has a water-absorption amount of 10 mL/m² or less between the contact and 30 msec^{1/2} after the contact according to Bristow method.

For example, plastic films of vinyl chloride resin, polyethylene terephthalate (PET), acrylic resins, polypropylene, polyethylene, and polycarbonate are suitably used for the non-permeating substrate.

(Printing Method and Inkjet Printing Apparatus)

A printing method of the present disclosure is a printing method including a step of applying an ink containing a colorant, and a step of applying a clear ink. As the clear ink, the clear ink of the present disclosure is used. The printing method of the present disclosure is not particularly limited so long as the printing method is a method for forming a clear ink layer over a color image.

In the printing method of the present disclosure, the step of applying an ink containing a colorant and a step of applying a clear ink may be performed with the same printing apparatus or may be performed with different printing apparatuses.

An example of a case where the printing method of the present disclosure is performed by an inkjet printing apparatus will be described.

In the following description of the recording apparatus and the recording method, a case of using a black (K) ink, a cyan (C) ink, a magenta (M) ink, and a yellow (Y) ink will be described. Instead, or in addition, a clear ink may be used.

The clear ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device).

The printing device and the printing method represent a device capable of discharging ink, various processing fluids, etc. to a print medium and a method printing an image on the print medium using the device. The print medium means an article to which the ink or the various processing fluids can be attached at least temporarily. The printing device encompasses an inkjet printing apparatus of the present disclosure. The inkjet printing apparatus is an inkjet printing apparatus including a discharging unit configured to discharge an ink. The inkjet printing apparatus includes the clear ink of the present disclosure.

The inkjet printing device includes both a serial type device in which the liquid discharging head is caused to move and a line type device in which the liquid discharging head is not moved, unless otherwise specified.

Furthermore, in addition to the desktop type, this inkjet printing device includes a wide type, a continuous printer capable of using continuous paper wound up in a roll form as print media.

The printing device may further optionally include a device relating to feeding, conveying, and ejecting the print medium and other devices referred to as a preprocessing device, a post-processing device, etc. in addition to the head portion to discharge the ink.

In addition, the printing device and the printing method are not limited to those producing merely meaningful visible images such as texts and figures with the ink. For example, the printing device and the printing method can produce patterns like geometric design and 3D images.

The inkjet printing device includes both a serial type device in which the liquid discharging head is caused to move and a line type device in which the liquid discharging head is not moved, unless otherwise specified.

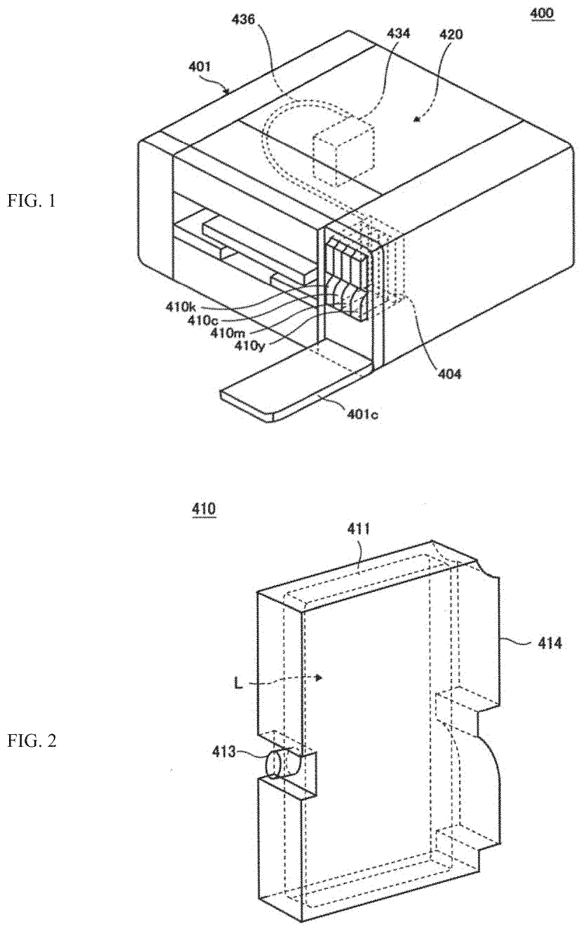

Furthermore, in addition to the desktop type, this printing device includes a wide type capable of printing images on a large print medium such as AO, a continuous printer capable of using continuous paper wound up in a roll form as print media. The printing device of the present disclosure is described using an example with reference to FIG. 1 and FIG. 2. FIG. 1 is a perspective view illustrating the printing device. FIG. 2 is a perspective view illustrating the main tank. An image forming apparatus 400 as an example of the printing device is a serial type image forming apparatus. A mechanical unit 420 is disposed in an exterior 401 of the image forming apparatus 400. Each ink accommodating unit (ink container) 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color.

A cartridge holder 404 is disposed on the rear side of the opening when a cover 401c of the main body is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a print medium.

This printing device may include not only a portion discharging ink but also a device referred to as a pre-processing device, a post-processing device, etc.

As an example of the pre-processing device and the post-processing device, as in the case of the ink such as black (K), cyan (C), magenta (M), and yellow (Y), a liquid container containing a pre-processing fluid or a post-processing fluid and a liquid discharging head are added to discharge the pre-processing fluid or the post-processing fluid in an inkjet printing method.

As another example of the pre-processing device and the post-processing device, it is suitable to dispose a pre-processing device and a post-processing device employing a blade coating method, a roll coating method, or a spray coating method other than the inkjet printing method.

How to use the ink is not limited to the inkjet printing method. Specific examples of such methods other than the inkjet printing method include, but are not limited to, blade coating methods, gravure coating methods, bar coating methods, roll coating methods, dip coating methods, curtain coating methods, slide coating methods, die coating methods, and spray coating methods.

The applications of the ink of the present disclosure are not particularly limited and can be suitably selected to suit to a particular application. For example, the ink can be used for printed matter, a paint, a coating material, and foundation. The ink can be used to form two-dimensional texts and images and furthermore a three-dimensional solid object (3D modeling object) as a material for 3D modeling.

An apparatus for fabricating a three-dimensional object can be any known device with no particular limit. For example, the apparatus includes an ink container, a supplying device, and a discharging device, a drier, etc. The three-dimensional solid object includes an object manufactured by re-applying ink. In addition, the threedimensional solid object can be manufactured by processing a structure having a substrate such as a print medium printed with the ink as a molded processed product. The molded processed product is fabricated by, for example, heating drawing or punching a structure or printed matter having a sheet-like form, film-like form, etc. The molded processed product is suitable as a product of molding performed after surface-decoration. Examples thereof are gauges or operation panels of vehicles, office machines, electric and electronic machines, cameras, etc.

<Inkjet Printing Apparatus>

As a result of earnest studies of the present inventor, it has been found possible to obtain a more stable discharging reliability by discharging the clear ink described above using an inkjet printing apparatus (may also be referred to as “apparatus configured to discharge an ink”) including a discharging head which includes a circulation mechanism described below.

The inkjet printing apparatus of the present disclosure includes a discharging head including: the clear ink described above; an individual liquid chamber including a circulation flow path through which the clear ink circulates; and a nozzle communicating with the individual liquid chamber to discharge a liquid droplet, and further includes other members as needed.

The discharging head is provided with a pressure sensor configured to detect the pressure of the clear ink, and a circulation speed control unit configured to control the circulation speed at which the clear ink is circulated.

It is preferable to control the circulation speed in a manner that a desired pressure can be obtained. With this control, the inkjet printing apparatus can suppress subsidence of particles and maintain a uniform dispersion state.

In terms of suppressing subsidence of particles, it is preferable that the circulation speed control unit raise the circulation speed when a value detected by the pressure sensor is lower than a desired pressure.

An embodiment of the present disclosure will be described below with reference to the attached drawings.

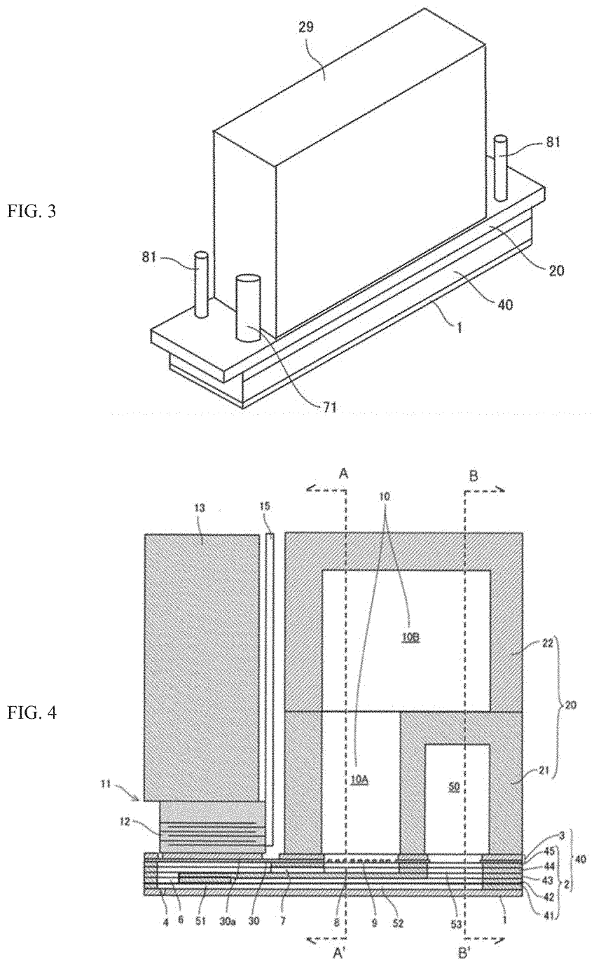

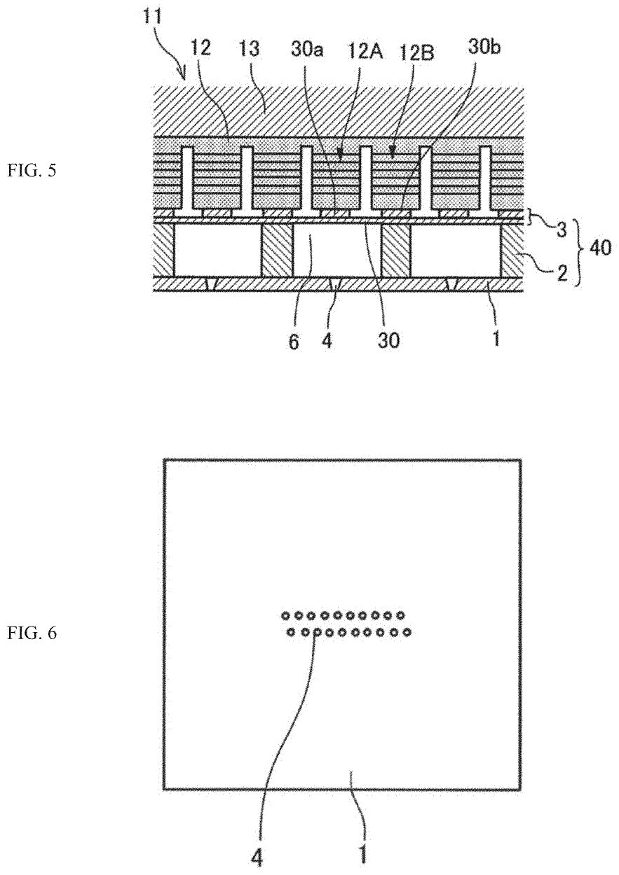

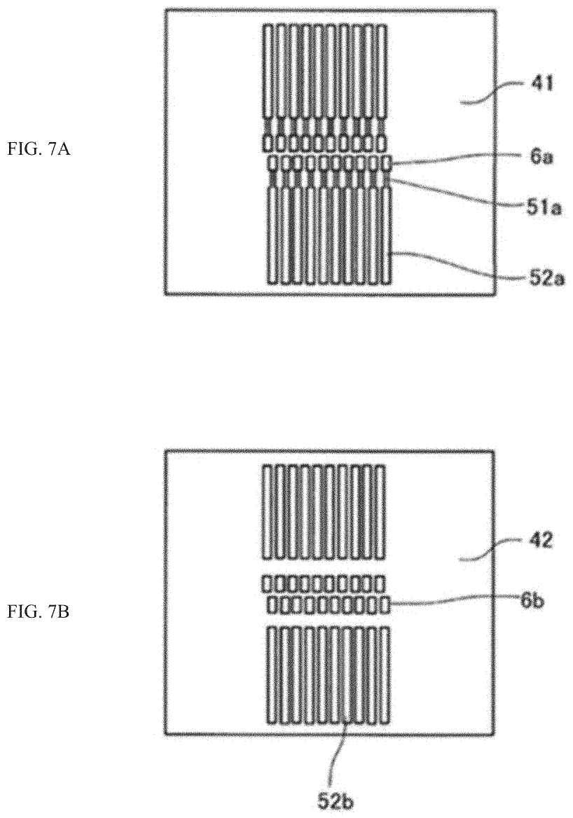

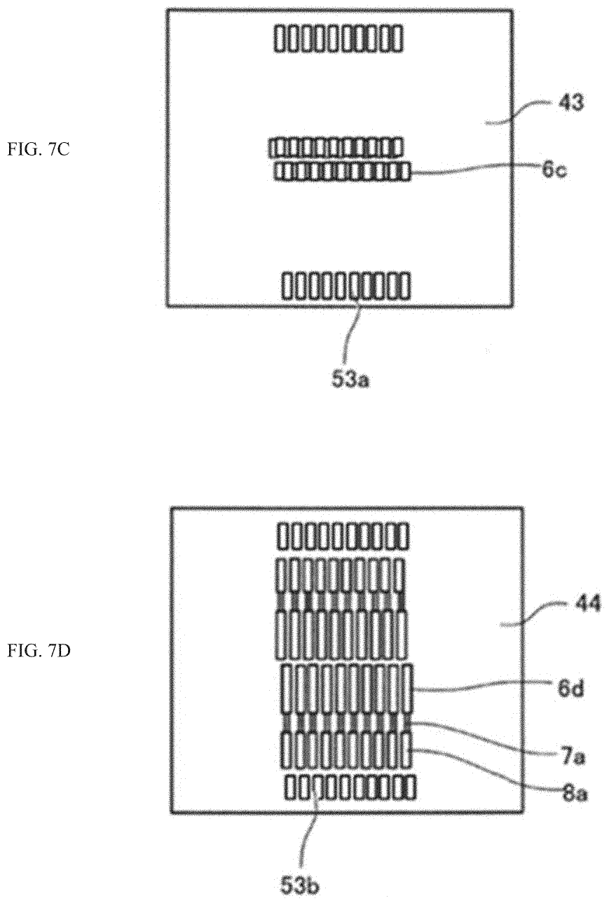

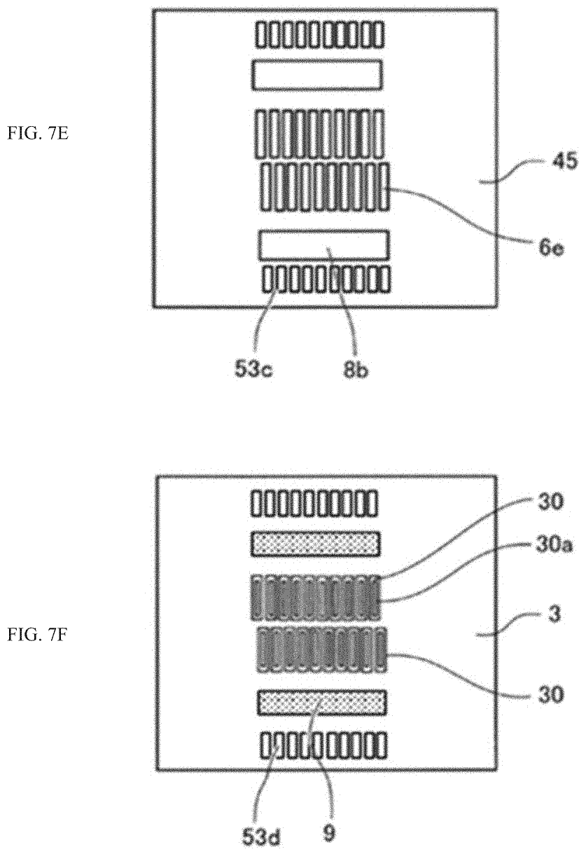

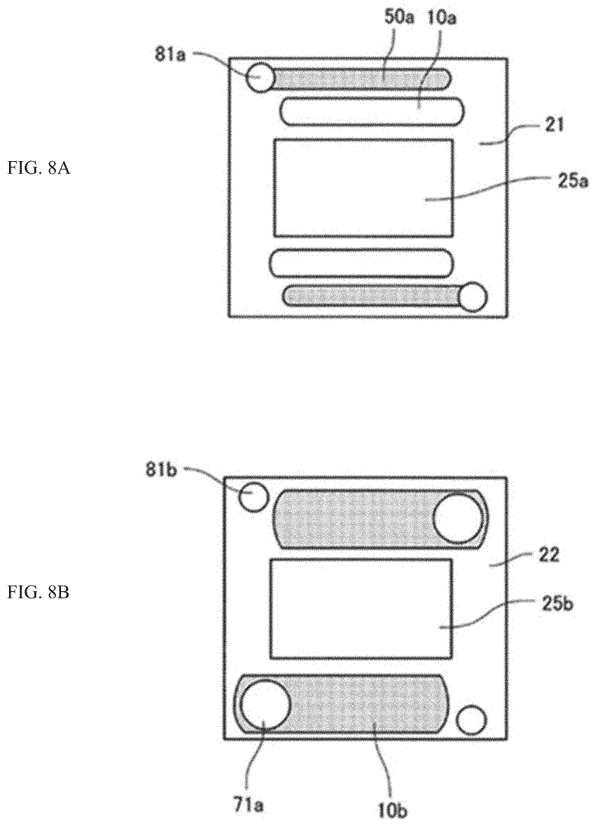

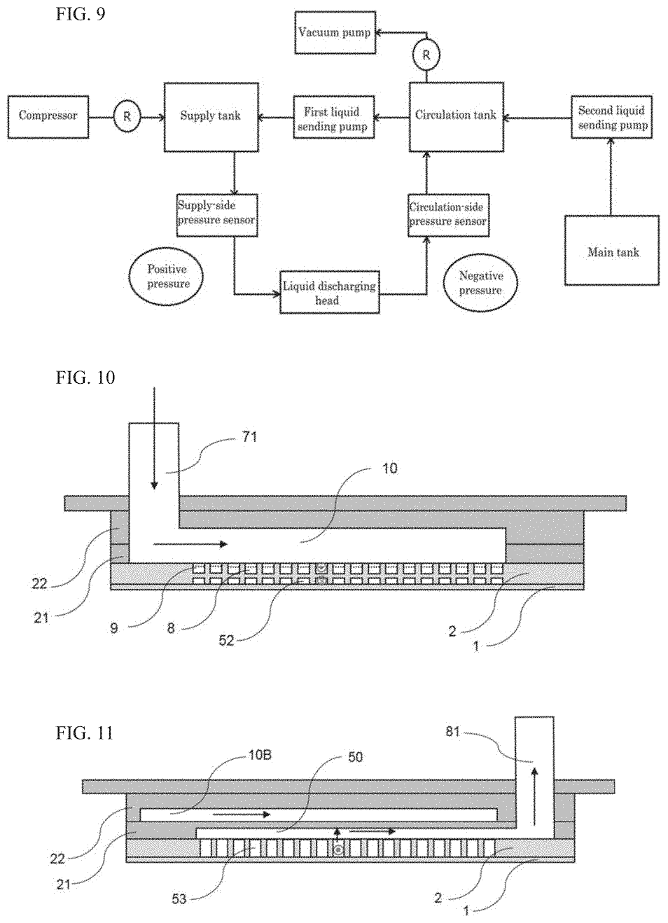

An example of a discharging head according to an embodiment of the present disclosure will be described with reference to FIG. 3 to FIG. 11. FIG. 3 is an outer perspective view of a discharging head according to an embodiment of the present disclosure. FIG. 4 is a cross-sectional view of a discharging head according to an embodiment of the present disclosure taken in a direction orthogonal to a direction in which nozzles are arranged. FIG. 5 is a cross-sectional view of a discharging head according to an embodiment of the present disclosure taken in a direction parallel with a direction in which nozzles are arranged. FIG. 6 is a plan view of a nozzle plate of a discharging head according to an embodiment of the present disclosure. FIG. 7A to FIG. 7F are plan views of each member constituting a flow path member of a discharging head according to an embodiment of the present disclosure. FIGS. 8A and 8B are plan views of each member constituting a common liquid chamber member of a discharging head according to an embodiment of the present disclosure. FIG. 9 is a block diagram illustrating an example of a liquid circulation system used in the present disclosure. FIG. 10 is a cross-sectional view taken along a line A-A′ of FIG. 4. FIG. 11 is a cross-sectional view taken along a line B-B′ of FIG. 4.

The discharging head is a layered joined body of a nozzle plate 1, a flow path plate 2, and a vibration plate member 3 serving as a wall surface member. The discharging head includes a piezoelectric actuator 11 configured to displace the vibration plate member 3, a common liquid chamber member 20, and a cover 29.

The nozzle plate 1 includes a plurality of nozzles 4 through which the clear ink is discharged.

The flow path plate 2 forms individual liquid chambers 6 leading to the nozzles 4, fluid resistor sections 7 leading to the individual liquid chambers 6, and liquid introducing sections 8 leading to the fluid resistor sections 7. The flow path plate 2 is formed of a plurality of plate-shaped members 41 to 45 that are layered and joined one after another on the nozzle plate 1. A flow path member 40 is a layered joined body of these plate-shaped members 41 to 45 and the vibration plate member 3.

The vibration plate member 3 includes filter sections 9 serving as openings that communicate the liquid introducing sections 8 with a common liquid chamber 10 formed of the common liquid chamber member 20.

The vibration plate member 3 is a wall surface member that forms the wall surfaces of the individual liquid chambers 6 of the flow path plate 2. The vibration plate member 3 is a two-layered structure (not limited to a two-layered structure). From the flow path member 2 side, the vibration plate member 3 includes a first layer that forms thin wall sections and a second layer that forms thick wall sections. Portions of the first layer corresponding to the individual liquid chambers 6 form deformable vibration regions 30.

As illustrated in FIG. 6, the plurality of nozzles 4 are arranged in a staggered formation on the nozzle plate 1.

As illustrated in FIG. 7A, through grooves (i.e., groove-shaped through-holes) 6a constituting the individual liquid chambers 6, and through grooves 51a and 52a constituting fluid resistor sections 51 and circulation flow paths 52 are formed in the plateshaped member 41 constituting the flow path plate 2.

Likewise, as illustrated in FIG. 7B, through grooves constituting the individual liquid chambers 6, and through grooves 52b constituting the circulation flow path 52 are formed in the plate-shaped member 42.

Likewise, as illustrated in FIG. 7C, through grooves 6c constituting the individual liquid chambers 6, and through grooves 53a constituting circulation flow paths 53 and having the longer dimension in the nozzle arranging direction are formed in the plateshaped member 43.

Likewise, as illustrated in FIG. 7D, through grooves 6d constituting the individual liquid chambers 6, through grooves 7a constituting the fluid resistor sections 7, through grooves 8a constituting the liquid introducing sections 8, and through grooves 53b constituting the circulation flow paths 53 and having the longer dimension in the nozzle arranging direction are formed in the plate-shaped member 44.

Likewise, as illustrated in FIG. 7E, through grooves 6e constituting the individual liquid chambers 6, through grooves 8b (forming liquid chambers downstream of the filter) constituting the liquid introducing sections 8 and having the longer dimension in the nozzle arranging direction, and through grooves 53c constituting the circulation flow paths 53 and having the longer dimension in the nozzle arranging direction are formed in the plate-shaped member 45.

As illustrated in FIG. 7F, the vibration regions 30, the filter sections 9, and through grooves 53d constituting the circulation flow paths 53 and having the longer dimension in the nozzle arranging direction are formed in the vibration plate member 3. By forming the flow path member as a layered joined body of a plurality of plateshaped members in the way described above, it is possible to form a complicated flow path with a simple configuration.

With the configuration described above, the fluid resistor sections 51 leading to the individual liquid chambers 6 and extending in the in-plane direction of the flow path plate 2, and the circulation flow paths 52 and the circulation flow paths 53 leading to the circulation flow paths 52 and extending in the direction of the thickness of the flow path member 40 are formed in the flow path member 40 formed of the flow path plate 2 and the vibration plate member 3. The circulation flow paths 53 lead to a common circulation liquid chamber 50 described below.

A common liquid chamber 10 to which the clear ink is supplied from a supply/circulation mechanism 494, and a common circulation liquid chamber 50 are formed in the common liquid chamber member 20.

As illustrated in FIG. 8A, a through hole 25a for piezoelectric actuator, a through groove 10a serving as a downstream common liquid chamber 10A, and a bottomed groove 50a serving as the common circulation liquid chamber 50 are formed in a first common liquid chamber member 21 constituting the common liquid chamber member 20.

Likewise, as illustrated in FIG. 8B, a through hole 25b for piezoelectric actuator and a groove 10b serving as an upstream common liquid chamber 10B are formed in a second common liquid chamber member 22.

With reference to also FIG. 3, a through hole 71a serving as a supply opening leading one end of the common liquid chamber 10 in the nozzle arranging direction to a supply port 71 is formed in the second common liquid chamber member 22.

Likewise, through holes 81a and 81b leading the other end of the common circulation liquid chamber 50 in the nozzle arranging direction (the other end being an end opposite to the through hole 71a) to a circulation port 81 are formed in the first common liquid chamber member 21 and the second common liquid chamber member 22.

In FIG. 8A and FIG. 8B, bottomed grooves are illustrated with solid painting (the same applies in the drawings to be mentioned below).

In the way described above, the common liquid chamber member 20 is formed of the first common liquid chamber member 21 and the second common liquid chamber member 22. The first common liquid chamber member 21 is joined to the vibration plate member 3 side of the flow path member 40, and the second common liquid chamber member 22 is layered and joined to the first common liquid chamber member 21.

The first common liquid chamber member 21 forms the downstream common liquid chamber 10A, which is a part of the common liquid chamber 10 leading to the liquid introducing sections 8, and the common circulation liquid chamber 50 leading to the circulation flow paths 53. The second common liquid chamber member 22 forms the upstream common liquid chamber 10B, which is the remaining part of the common liquid chamber 10.

The downstream common liquid chamber 10A, which is a part of the common liquid chamber 10, and the common circulation liquid chamber 50 are disposed side by side in a direction orthogonal to the nozzle arranging direction, and the common circulation liquid chamber 50 is disposed at a position at which the common circulation liquid chamber 50 is projected inside the common liquid chamber 10.

This allows the dimension of the common circulation liquid chamber 50 not to be constrained by the dimension needed for the flow paths including the individual liquid chambers 6, the fluid resistor sections 7, and the liquid introducing sections 8 formed by the flow path member 40.

With the common circulation liquid chamber 50 and a part of the common liquid chamber 10 disposed side by side and with the common circulation liquid chamber 50 disposed at a position projected inside the common liquid chamber 10, the width of the head in the direction orthogonal to the nozzle arranging direction can be suppressed and the size of the head can be suppressed. The common liquid chamber member 20 forms the common liquid chamber 10 to which the clear ink is supplied from a head tank or a clear ink cartridge, and the common circulation liquid chamber 50. The piezoelectric actuator 11 including an electromechanical transducing element serving as a driving unit configured to deform the vibration regions 30 of the vibration plate member 3 is disposed at a side of the vibration plate member 3 opposite to a side at which the individual liquid chambers 6 are provided.

As illustrated in FIG. 5, the piezoelectric actuator 11 includes a piezoelectric member joined to a base member 13. The piezoelectric member is grooved by half-cut dicing in a manner that a needed number of columnar piezoelectric elements 12A and 12B are formed in the one piezoelectric member at predetermined intervals in a comb-teeth formation.

The piezoelectric element 12A is configured to be driven as a piezoelectric element with application of a driving waveform, whereas the piezoelectric element 12B is used as a mere support without application of a driving waveform. However, the piezoelectric elements 12A and 12B may all be driven as piezoelectric elements. The piezoelectric element 12A is joined to a protrusion 30a, which is an island-shaped thick wall section formed in the vibration region 30 of the vibration plate member 3. The piezoelectric element 12B is joined to a protrusion 30b, which is a thick wall section of the vibration plate member 3.

The piezoelectric member is an alternate laminate of piezoelectric layers and internal electrodes. The internal electrodes are each led out to an end surface to form an external electrode. A flexible wiring member 15 is coupled to the external electrode.

In the discharging head configured as described above, for example, when the voltage applied to the piezoelectric element 12A is dropped below a reference potential, the piezoelectric element 12A shrinks and the vibration region 30 of the vibration plate member 3 descends, to expand the volume of the individual liquid chamber 6 and cause the clear ink to flow into the individual liquid chamber 6.

Subsequently, the voltage applied to the piezoelectric element 12A is raised in order to elongate the piezoelectric element 12A in the layering direction, deform the vibration region 30 of the vibration plate member 3 in the direction toward the nozzle 4, and shrink the volume of the individual liquid chamber 6. As a result, the clear ink in the individual liquid chamber 6 is pressurized and discharged through the nozzle 4. Then, by the surface tension of the clear ink, the clear ink is pulled out from the common liquid chamber 10 for replenishment. Finally, the meniscus surface stabilizes based on the balance between the surface tension of the meniscus and a negative pressure defined by a supply tank, a circulation tank, and a water head differential. This enables the next discharging operation.

The head driving method is not limited to the example described above (i.e., pull-push discharge). Depending on how to apply the driving waveform, pull discharge and push discharge may be performed. In the embodiment described above, layered piezoelectric elements are described as a pressure generating unit configured to apply pressure fluctuation to the individual liquid chambers 6. This is a non-limiting example, and a thin film-shaped piezoelectric element may be used. Moreover, a heat resistor may be disposed in the individual liquid chamber 6 in order to apply pressure fluctuation by bubbles generated by heat generation of the heat resistor, or an electrostatic force may be used in order to generate pressure fluctuation.

Next, an example of a clear ink circulation system using the discharging head according to the present embodiment will be described with reference to FIG. 9.

FIG. 9 is a block diagram illustrating a clear ink circulation system according to the present embodiment.

As illustrated in FIG. 9, the clear ink circulation system includes, for example, a main tank, a discharging head, a supply tank, a circulation tank, a compressor, a vacuum pump, liquid sending pumps, a regulator (R), a supply-side pressure sensor, and a circulation-side pressure sensor, and further includes a circulation speed control unit configured to adjust the ink circulation speed throughout the system. The supplyside pressure sensor is positioned between the supply tank and the discharging head and coupled to a supply flow path side leading to the supply port 71 (see FIG. 3) of the discharging head. The circulation-side pressure sensor is positioned between the discharging head and the circulation tank and coupled to the circulation flow path side leading to the circulation port 81 (see FIG. 3) of the discharging head.

One side of the circulation tank is coupled to the supply tank via the first liquid sending pump, and the other side of the circulation tank is coupled to the main tank via the second liquid sending pump. This causes the clear ink to flow from the supply tank into the discharging head through the supply port 71, then to be drained into the circulation tank through the circulation port, and then to be sent from the circulation tank into the supply tank by the first liquid sending pump. In this way, the clear ink circulates.

The compressor is coupled to the supply tank in order to control a predetermined positive pressure to be sensed by the supply-side pressure sensor. On the other hand, the vacuum pump is coupled to the circulation tank in order to control a predetermined negative pressure to be sensed by the circulation-side pressure sensor. This makes it possible to maintain the negative pressure of the meniscus at a constant level while circulating the clear ink through the discharging head.

When liquid droplets are discharged through the nozzles of the discharging head, the amounts of the clear ink in the supply tank and the circulation tank are reduced. Therefore, it is desirable to appropriately replenish the circulation tank with the clear ink from the main tank using the second liquid sending pump. The timing at which the circulation tank is replenished with the clear ink from the main tank can be controlled based on a sensing result of, for example, a liquid surface sensor provided in the circulation tank, in a manner that, for example, replenishment of the clear ink is performed when the liquid surface height of the ink in the circulation tank drops below a predetermined height.

Next, circulation of the clear ink in the discharging head will be described. As illustrated in FIG. 3, the supply port 71 leading to the common liquid chamber and the circulation port 81 leading to the common circulation liquid chamber 50 are formed at an end of the common liquid chamber member 20. The supply port 71 and the circulation port 81 are coupled, through tubes, to the supply tank and the circulation tank storing the clear ink (see FIG. 9). The clear ink stored in the supply tank is supplied into the individual liquid chambers 6 through the supply port 71, the common liquid chamber 10, the liquid introducing sections 8, and the fluid resistor sections 7. Further, while the clear ink in the individual liquid chambers 6 is discharged through the nozzles 4 under driving of the piezoelectric element 12, part or the whole of the clear ink remaining in the individual liquid chamber 6 without being discharged is circulated to the circulation tank through the fluid resistor sections 51, the circulation flow paths 52 and 53, the common circulation liquid chamber 50, and the circulation port 81.

Circulation of the clear ink may be performed not only during the operation time of the discharging head, but also during suspension of the operation. It is preferable to perform circulation during suspension of the operation, because this makes it possible to constantly refresh the clear ink in the individual liquid chambers and suppress aggregation and subsidence of the components contained in the clear ink.

Further, in the present disclosure, when the ink contains particles that easily subside, the particles may subside or adhere in the circulation flow paths if the ink circulation speed is low. This increases the resistance in the circulation flow paths and makes the value to be detected by the supply-side pressure sensor or the circulation-side pressure sensor low. In this case, it is possible to resolve the subsided matter by controlling the ink circulation speed to be higher.

Specifically, when the value detected by the supply-side pressure sensor or the circulation-side pressure sensor becomes lower than a previously set target lower limit value (for example, lower than the half of the pressure in the normal state), the flow rate is controlled to increase the pressure to a target pressure (the pressure in the normal state) at a previously set pressure change rate. This increased flow rate is maintained until a previously defined time passes from the timing at which a detected value reaches the target pressure. As a result, the subsided matter can be resolved.

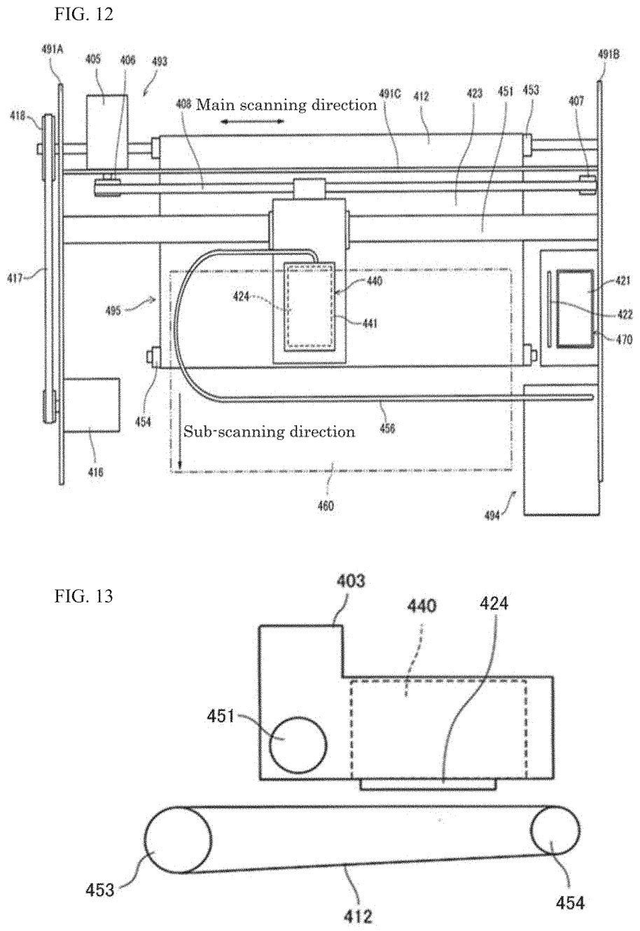

Next, an example of the inkjet printing apparatus according to the present disclosure will be described with reference to FIG. 12 and FIG. 13. FIG. 12 is a main part plan view illustrating the inkjet printing apparatus, and FIG. 13 is a main part side view of the inkjet printing apparatus.

The inkjet printing apparatus is a serial type apparatus, and a main-scanning moving mechanism 493 moves a carriage 403 reciprocably in the main scanning direction. The main-scanning moving mechanism 493 includes, for example, a guide member 401, a main-scanning motor 405, and a timing belt 408. The guide member 401 is suspended between the left and right side panels 491A and 491B and supports the carriage 403 movably. The main-scanning motor 405 reciprocably moves the carriage 403 in the main scanning direction via the timing belt 408 suspended between a driving pulley 406 and a driven pulley 407.

The carriage 403 is mounted with a discharging unit 440 mounted with a discharging head 404 according to the present disclosure. The discharging head 404 in the discharging unit 440 is configured to discharge inks of, for example, yellow (Y), cyan (C), magenta (M), and black (K) colors. The discharging head 404 is mounted in a state that nozzle lines including a plurality of nozzles are aligned in a sub-scanning direction orthogonal to the main scanning direction and the discharging direction is downward.

A supply/circulation mechanism 494 configured to supply an ink stored outside the discharging head 404 into the discharging head 404 supplies and circulates the ink in the discharging head 404. In this example, the supply/circulation mechanism 494 is formed of, for example, a supply tank, a circulation tank, a compressor, a vacuum pump, liquid sending pumps, and a regulator (R). A supply-side pressure sensor is positioned between the supply tank and the discharging head and coupled to a supply flow path side leading to the supply port 71 of the discharging head. A circulation-side pressure sensor is positioned between the discharging head and the circulation tank and coupled to a circulation flow path side leading to the circulation port 81 of the discharging head.

This apparatus includes a conveying mechanism 495 configured to convey a paper sheet 410. The conveying mechanism 495 includes a conveyor belt 412 serving as a conveying unit, and a sub-scanning motor 416 configured to drive the conveyor belt 412.

The conveyor belt 412 attracts a paper sheet 410 and conveys the paper sheet 410 from a position to another position at which the paper sheet 410 faces the discharging head 404. The conveyor belt 412 is an endless belt and suspended between a conveyor roller 413 and a tension roller 414. Attraction may be performed by electrostatic attraction or air suction.

With the sub-scanning motor 416 driving the conveyor roller 413 to rotate via a timing belt 417 and a timing pulley 418, the conveyor belt 412 rotationally moves in the subscanning direction.

A maintenance/recovery mechanism 420 configure to maintain and recover the discharging head 404 is positioned at one side of the carriage 403 in the main scanning direction and at a side of the conveyor belt 412.

The maintenance/recovery mechanism 420 includes, for example, a capping member 421 configured to cap the nozzle surface (a surface in which nozzles are formed) of the discharging head 404, and a wiper member 422 configured to wipe the nozzle surface. The main-scanning moving mechanism 493, the supply/circulation mechanism 494, the maintenance/recovery mechanism 420, and the conveying mechanism 495 are attached on the housing including the side panels 419A and 491B and a back panel 491C.

In the apparatus having such a configuration, the paper sheet 410 is fed and attracted to the conveyor belt 412, and conveyed in the sub-scanning direction by rotational movement of the conveyor belt 412.

Then, with the carriage 403 moved in the main scanning direction, the discharging head 404 is driven in accordance with an image signal, to discharge an ink and form an image over the paper sheet 410, which is being stopped.

Hence, the apparatus including the discharging head according to the present disclosure can stably form a high-quality image.

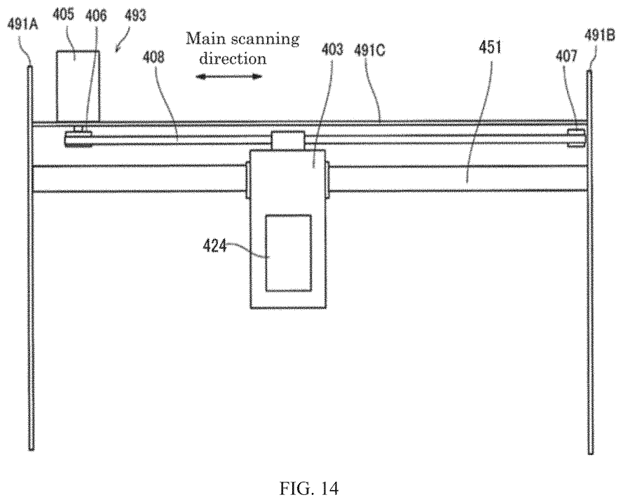

Next, another example of the discharging unit according to the present disclosure will be described with reference to FIG. 14. FIG. 14 is a main part plan view of the discharging unit.

The discharging unit is formed of the housing including the side panels 491A and 491B and the back panel 491C, the main-scanning moving mechanism 493, the carriage 403, and the discharging head 404 among the members constituting the apparatus configured to discharge an ink.

At least one of the maintenance/recovery mechanism 420 and the supply/circulation mechanism 494 may further be attached on, for example, the side panel 491B of this discharging unit, to configure another discharging unit.

In the present disclosure, a “discharging head” is a functional component configured to discharge or jet an ink through nozzles.

The ink to be discharged is not particularly limited so long as the ink has a viscosity and a surface tension at which the ink can be discharged from the head. A suitable ink has a viscosity of 30 mPa s or lower at normal temperature at normal pressure, or by heating or cooling. More specifically, the ink is, for example, a solution, a suspension, and an emulsion that contain a solvent such as water and an organic solvent, a colorant such as a dye and a pigment, a functionality adding material such as a polymerizable compound, a resin, and a surfactant, a biocompatible material such as DNA, amino acid, protein, and calcium, and an edible material such as a natural pigment, and can be used for applications such as an inkjet ink, a surface treatment fluid, a liquid for forming a component of an electronic element and a light-emitting element and an electronic circuit resist pattern, and a material liquid for producing a three-dimensional object.

Examples of the source for generating energy for discharging an ink include thermal actuators employing electrothermal transducing elements such as piezoelectric actuators (layered piezoelectric elements and thin-film-shaped piezoelectric elements) and heating resistors, and electrostatic actuators formed of a vibration plate and a counter electrode.

A “discharging unit” is an integrated body of a discharging head with functional parts and mechanisms, and an assembly of parts involved in ink discharging. For example, examples of a “discharging unit” include a combination of a discharging head with at least one of a supply/circulation mechanism, a carriage, a maintenance/recovery mechanism, and a main-scanning moving mechanism.

Here, examples of an integrated body include a discharging head and a functional part/mechanism secured to each other by, for example, fastening, bonding, and locking, and a discharging head movably supported on a functional part/mechanism and vice versa. The discharging head and the functional part/mechanism may be attachable and detachable with each other.

For example, examples of a liquid discharging unit include an integrated body of a discharging head and a supply/circulation mechanism, and an integrated body of a discharging head and a supply/circulation mechanism coupled to each other through, for example, a tube. A unit including a filter may be added between the supply/circulation mechanism and the discharging head of such a liquid discharging unit.

Examples of the discharging unit include an integrated body of a discharging head and a carriage.

Examples of the discharging unit include an integrated body of a discharging head and a scanning moving mechanism, with the discharging head movably supported on a guide member constituting a part of the scanning moving mechanism.

Examples of the discharging unit include an integrated body of a discharging head, a carriage, and a maintenance/recovery mechanism, with a cap member, which is a part of the maintenance/recovery mechanism, secured on the carriage mounted with the discharging head.

Examples of the discharging unit include an integrated body of a discharging head and a supply mechanism, with a tube coupled to the supply/circulation mechanism or to the discharging head provided with a flow path part. An ink in an ink storage is supplied to the discharging head through this tube.

Examples of the main-scanning moving mechanism include a guide member alone. Examples of the supply mechanism include a tube alone, and a loading part alone.

In the present disclosure, an “inkjet printing apparatus” is an apparatus including a discharging head or a discharging unit, and configured to drive the discharging head to discharge an ink. Examples of the apparatus configured to discharge an ink include not only an apparatus capable of discharging an ink to a liquid attachable target, but also an apparatus configured to discharge an ink into the air or into a liquid. This “inkjet printing apparatus” may include units involved in feeding, conveying, and ejecting an ink attachable target, and other units such as pre-processing device and a post-processing device.

Examples of the “inkjet printing apparatus” include an image forming apparatus configured to discharge an ink to form an image over paper, and a stereoscopic object producing apparatus (or a three-dimensional object producing apparatus) configured to discharge an object forming liquid to a powder layer obtained by forming a powder in a layer state, to produce a stereoscopic object (or a three-dimensional object). The inkjet printing apparatus is not limited to those producing merely meaningful visible images such as texts and figures with discharged liquid droplets. For example, the inkjet printing apparatus can produce, for example, meaningless patterns and 3D images.

The “ink attachable target” means an article to which an ink can be attached at least temporarily, or an article to which an ink is attached and fixed, or an article permeable by an ink attached thereon. Specific examples of the ink attachable target include recording media such as paper, recording paper, recording paper sheets, films, and cloths, electronic parts such as electronic substrates and piezoelectric elements, and media such as powder layers, organ models, and testing cells. Unless otherwise specified, the ink attachable target encompass all articles on which liquids attach.

The material of the “ink attachable target” may be anything on which a liquid can be attached at least temporarily, such as paper, threads, fiber, cloths, leather, metals, plastics, glass, woods, and ceramics.

The “ink” is not particularly limited so long as the ink has a viscosity and a surface tension at which the ink can be discharged from a head. A suitable ink has a viscosity of 30 mPa s or lower at normal temperature at normal pressure, or by heating or cooling. More specifically, the ink is, for example, a solution, a suspension, and an emulsion that contain a solvent such as water and an organic solvent, a colorant such as a dye and a pigment, a functionality adding material such as a polymerizable compound, a resin, and a surfactant, a biocompatible material such as DNA, amino acid, protein, and calcium, and an edible material such as a natural pigment, and can be used for applications such as an inkjet ink, a surface treatment fluid, a liquid for forming a component of an electronic element and a light-emitting element and an electronic circuit resist pattern, and a material liquid for producing a three-dimensional object.

The “inkjet printing apparatus” is an apparatus in which a discharging head and an ink attachable target move relative to each other. However, the inkjet printing apparatus is not limited to such an apparatus. Specific examples of the inkjet printing apparatus include a serial type apparatus in which the discharging head is caused to move and a line type apparatus in which the discharging head is not moved.

Other examples of the “inkjet printing apparatus” include a processing fluid coating apparatus configured to discharge a processing fluid over a paper sheet in order to coat the surface of the paper sheet with the processing fluid for, for example, reformation of the surface of the paper sheet, and a jet granulator configured to jet, through nozzles, a composition liquid obtained by dispersing a material in a solution, to produce particles of the material.

All of the terms such as image formation, recording, printing, and object formation as used herein have the same meaning.

### EXAMPLES

The present disclosure will be described below by way of Examples. The present disclosure should not be construed as being limited to these Examples. Unless otherwise described, preparation and evaluation were performed at room temperature of 25 degrees C. at a humidity of 60% RH.

(Preparation example 1)

<Preparation of resin emulsion 1>

-Polycarbonate-based polyurethane resin-

A reaction vessel into which a stirrer, a reflux condenser, and a thermometer were inserted was charged with polycarbonate diol (a reaction product of 1,6-hexanediol and dimethyl carbonate, with a number average molecular weight (Mn) of 1,200) (1,500 parts by mass), 2,2-dimethylolpropinonic acid (hereinafter may be referred to as “DMPA”) (300 parts by mass), and N-methyl pyrrolidone (hereinafter may be referred to as “NMP”) (1,420 parts by mass) under a nitrogen stream. The materials were heated to 60 degrees C. to dissolve DMPA.

Next, 4,4′-dicyclohexylmethane diisocyanate (1,824 parts by mass) and dibutyl tin dilaurate (catalyst) (2.6 parts by mass) were added to the resultant and heated to 90 degrees C., to allow the materials to undergo a urethanation reaction for five hours, to obtain an isocyanate-terminated urethane prepolymer. This reaction product was cooled to 80 degrees C. To the resultant, triethylamine (260 parts by mass) was added and mixed. From the resultant, 4,340 parts by mass was extracted and added in a mixture solution of water (5,400 parts by mass) and triethylamine (15 parts by mass) under strong stirring.

Next, ice (1,500 parts by mass) was added to the resultant, and a 35% by mass 2-methyl-1,5-pentanediamine aqueous solution (830 parts by mass) was added to the resultant to allow the materials to undergo a chain elongation reaction. The solvent was evaporated from the resultant to adjust the solid component concentration to 30% by mass, to obtain a resin emulsion 1.

The glass transition temperature (Tg) of the obtained resin emulsion 1 measured according to <Method for measuring glass transition temperature of resin emulsion>described below was 55 degrees C. The volume average particle diameter of the resin emulsion 1 measured with a particle size analyzer (NANOTRAC WAVE II, obtained from MicrotracBEL Corporation) was 44 nm.

<Method for Measuring Glass Transition Temperature of Resin Emulsion>

The glass transition temperature of the resin emulsion was measured with differential scanning calorimeters (TA-60WS and DSC-60, obtained from Shimadzu Corporation). The resin emulsion (4 g) was poured into a petri dish having a diameter of 50 mm and formed of a tetrafluoroethylene/perfluoroalkyl vinyl ether copolymer (PFA) in a manner that the resin emulsion would spread uniformly. The resin emulsion was dried at 50 degrees C. for one week, to obtain a resin film. Five point zero milligrams of the resin film was put in a sample container formed of aluminum, and the sample container was put on a holder unit and set in an electric furnace. Next, under a nitrogen atmosphere, the sample was subjected to temperature elevation from 0 degrees C. to 150 degrees C. at a temperature elevation rate of 10 degrees C./min, then to temperature reduction from 150 degrees C. to −80 degrees C. at a temperature reduction rate of 5 degrees C./min, and then further to temperature elevation to 150 degrees C. at a temperature elevation rate of 10 degrees C./min, to measure a DSC curve. With an analyzing program of the DSC-60 system, the obtained DSC curve was analyzed by a mid-point method based on the inflection point in the second temperature elevation, to obtain a glass transition temperature (Tg).

### Preparation Example 2

<Preparation of Resin Emulsion 2>

-Polyester-Based Polyurethane Resin-

A reaction vessel having a capacity of 2 L and equipped with a stirrer, a thermometer, a nitrogen-sealed tube, and a cooler was charged with methyl ethyl ketone (100 parts by mass), polyester polyol obtained from polyester polyol (1) (iPA/AA= 6/4 (ratio by mole)) and EG/NPG= 1/9 (ratio by mole) (with a number average molecular weight: 2,000, and an average number of functional groups: 2, iPA: isophthalic acid, AA: adipic acid, EG: ethylene glycol, and NPG: neopentyl glycol) (345 parts by mass), and 2,2-dimethylolpropionic acid (DMPA) (9.92 parts by mass). The materials were mixed uniformly at 60 degrees C.

Subsequently, triethylene glycol diisocyanate (TEGDI) (40.5 parts by mass) and dioctyl tin dilaurate (DOTDL) (0.08 parts by mass) were added to the resultant, and allowed to undergo reaction at 72 degrees C. for three hours, to obtain a polyurethane solution.

IPA (80 parts by mass), MEK (220 parts by mass), triethanolamine (TEA) (3.74 parts by mass), and water (596 parts by mass) were added to the polyurethane solution to change the phase of the polyurethane solution. Subsequently, MEK and IPA were removed from the resultant with a rotary evaporator, to obtain a resin emulsion 2.

After the obtained aqueous emulsion was cooled to normal temperature, ionexchanged water and a sodium hydroxide aqueous solution were added to the resultant to adjust the solid component concentration to 30% by mass and pH to 8.

The glass transition temperature (Tg) of the prepared resin emulsion 2 measured in the same manner as the resin emulsion 1 was −4 degrees C.

The volume average particle diameter of the prepared resin emulsion 2 measured in the same manner as the resin emulsion 1 was 105 nm.

### Preparation Example 3

<Preparation of Resin Emulsion 3>

-Polycarbonate-Based Polyurethane Resin-

A reaction vessel into which a stirrer, a reflux condenser, and a thermometer were inserted was charged with polycarbonate diol (a reaction product of 1,6-hexanediol and dimethyl carbonate, with a number average molecular weight (Mn): 1,000) (1,500 parts by mass), 2,2-dimethylolpropionic acid (hereinafter may be referred to as “DMPA”) (260 parts by mass), and N-methyl pyrrolidone (hereinafter may be referred to as “NMP”) (1,320 parts by mass) under a nitrogen stream. The materials were heated to 60 degrees C. to dissolve DMPA.

Next, 4,4′-dicyclohexylmethane diisocyanate (1,530 parts by mass) and dibutyl tin laurate (catalyst) (2.6 parts by mass) were added to the resultant and heated to 90 degrees C., to allow the materials to undergo a urethanation reaction for five hours, to obtain an isocyanate-terminated urethane prepolymer. This reaction mixture was cooled to 80 degrees C. Triethylamine (245 parts by mass) was added and mixed in the resultant. From the resultant, 4,340 parts by mass was extracted and added in a mixture solution of water (5,400 parts by mass) and triethylamine (15 parts by mass) under strong stirring.

Next, ice (1,500 parts by mass) was added to the resultant, and a 35% by mass 2-methyl-1,5-pentanediamine aqueous solution (793 parts by mass) was added to the resultant, to allow the materials to undergo a chain elongation reaction. The solvent was evaporated from the resultant to adjust the solid component concentration to 30% by mass, to obtain a resin emulsion 3.

The glass transition temperature (Tg) of the obtained resin emulsion 3 measured in the same manner as the resin emulsion 1 was 45 degrees C. The volume average particle diameter of the resin emulsion 3 measured in the same manner as the resin emulsion 1 was 40 nm.

### Preparation Example 4

<Preparation of Resin Emulsion 4>

-Polycarbonate-Based Polyurethane Resin-

A reaction vessel into which a stirrer, a reflux condenser, and a thermometer were inserted was charged with polycarbonate diol (a reaction product of 1,6-hexanediol and dimethyl carbonate, with a number average molecular weight (Mn) of 1,200) (1,500 parts by mass), 2,2-dimethylolpropionic acid (hereinafter may be referred to as “DMPA”) (350 parts by mass), and N-methyl pyrrolidone (hereinafter may be referred to as “NMP”) (2,300 parts by mass) under a nitrogen stream. The materials were heated to 60 degrees C. to dissolve DMPA.

Next, 4,4′-dicyclohexylmethane diisocyanate (2,100 parts by mass) and dibutyl tin dilaurate (catalyst) (2.6 parts by mass) were added to the resultant and heated to 90 degrees C., to allow the materials to undergo a urethanation reaction for five hours, to obtain an isocyanate-terminated urethane prepolymer. This reaction mixture was cooled to 80 degrees C. Triethylamine (270 parts by mass) was added and mixed in the resultant. From the resultant, 4,340 parts by mass was extracted and added in a mixture solution of water (5,400 parts by mass) and triethylamine (15 parts by mass) under strong stirring.

Next, ice (1,500 parts by mass) was added to the resultant, and a 35% by mass 2-methyl-1,5-pentanediamine aqueous solution (800 parts by mass) was added to the resultant, to allow the materials to undergo a chain elongation reaction. The solvent was evaporated from the resultant to adjust the solid component concentration to 30% by mass, to obtain a resin emulsion 4.

The glass transition temperature (Tg) of the obtained resin emulsion 4 measured in the same manner as the resin emulsion 1 was 56 degrees C. The volume average particle diameter of the resin emulsion 4 measured in the same manner as the resin emulsion 1 was 57 nm.

### Production Example 1

-Production of clear ink A-

The resin emulsion 1 of Preparation example 1 (with a solid component concentration of 30% by mass) (29.6% by mass), the resin emulsion 2 of Preparation example 2 (with a solid component concentration of 30% by mass) (0.4% by mass), 1,2-propanediol (16.5% by mass), 1,3-propanediol (11% by mass), 1,2-butanediol (3% by mass), a surfactant “FS-300” (product name) (obtained from Du Pont K. K., a flurosurfactant, with a solid component concentration of 40% by mass) (6% by mass), and highly pure water (33.5% by mass) were added together and mixed and stirred, to prepare a mixture.

Next, the obtained mixture was filtrated through a polypropylene filter having an average pore diameter of 0.2 micrometers (product name: BETAFINE POLYPROPYLENE PLEATED FILTER PPG SERIES, obtained from 3M Limited), to produce a clear ink A.

### Production Examples 2 to 10

-Production of clear inks B to J-

Clear inks B to J were produced in the same manner as in Production example 1, except that unlike in Production example 1, the ink composition was changed to as presented in Tables 1-1 and 1-2.

The glass transition temperature (Tg) of dried films of the clear inks A to J was measured according to <Method for measuring glass transition temperature of dried film of clear ink>described below. The volume average particle diameter of the clear inks was measured in the same manner as the resin emulsion 1.

The resin solid component concentration (% by mass) in the clear inks, and a mass ratio MA:MB between the mass MA of resin particles A having Tg of 50 degrees C. or higher and the mass MB of resin particles B having Tg of lower than 0 degrees C. in the clear inks are presented in Table 1 collectively with the measurements of Tg of each ink and the measurements of the volume average particle diameter of each clear ink.

<Method for Measuring Glass Transition Temperature of Dried Film of Clear Ink>

The glass transition temperature of a dried film of a clear ink was measured with differential scanning calorimeters (TA-60WS and DSC-60, obtained from Shimadzu Corporation).

The clear ink (4 g) was poured into a petri dish having a diameter of 50 mm and formed of a tetrafluoroethylene/perfluoroalkyl vinyl ether copolymer (PFA) in a manner that the clear ink would spread uniformly. The clear ink was dried at 50 degrees C. for one week, to obtain an ink film. Five point zero milligrams of the ink film was put in a sample container formed of aluminum, and the sample container was put on a holder unit and set in an electric furnace. Next, under a nitrogen atmosphere, the sample was subjected to temperature elevation from 0 degrees C. to 150 degrees C. at a temperature elevation rate of 10 degrees C./min, then to temperature reduction from 150 degrees C. to −80 degrees C. at a temperature reduction rate of 5 degrees C./min, and then further to temperature elevation to 150 degrees C. at a temperature elevation rate of 10 degrees C./min, to measure a DSC curve. With an analyzing program of the DSC-60 system, the obtained DSC curve was analyzed by a mid-point method based on the inflection point in the second temperature elevation, to obtain a glass transition temperature (Tg).

TABLE 1-1

| | | Production | Production | Production | Production | Production |
|---|---|---|---|---|---|---|
| | | ex. 1 | ex. 2 | ex. 3 | ex. 4 | ex. 5 |
| | | Clear | Clear | Clear | Clear | Clear |
| | | ink A | ink B | ink C | ink D | ink E |
| Resin | Resin emulsion 1 | 29.6 | 29 | 27 | 24.5 | 23 |
| | Resin emulsion 2 | 0.4 | 1 | 3 | 5.5 | 7 |
| | Resin emulsion 3 | | | | | |
| | Resin emulsion 4 | | | | | |
| Water | Highly pure water | 33.5 | 33.5 | 33 | 32 | 31 |
| Surfactant | FS-300 | 6 | 6 | 6 | 6 | 6 |
| Organic | 1,2-Propanediol | 16.5 | 16.5 | 17 | 18 | 19 |
| solvent | 1,3-Propanediol | 11 | 11 | 11 | 11 | 11 |
| | 1,2-Butanediol | 3 | 3 | 3 | 3 | 3 |

| | | | | | |
|---|---|---|---|---|---|
| Total (% by mass) | 100 | 100 | 100 | 100 | 100 |
| Resin solid component in clear ink (% by mass) | 9 | 9 | 9 | 9 | 9 |
| Volume average particle diater of clear ink (nm) | 44 nm | 45 nm | 46 nm | 47 nm | 49 nm |
| MA:MB | 99:1 | 97:3 | 90:10 | 82:18 | 77:23 |
| Tg of dried film of clear ink | 55° C., | 55° C., | 54° C., | 54° C., | 54° C., |
| | −4° C. | −4° C. | −3° C. | −3° C. | −3° C. |

TABLE 1-2

| | | Production | Production | Production | Production | Production |
|---|---|---|---|---|---|---|
| | | ex. 6 | ex. 7 | ex. 8 | ex. 9 | ex. 10 |
| | | Clear | Clear | Clear | Clear | Clear |
| | | ink F | ink G | ink H | ink I | ink J |
| Resin | Resin emulsion 1 | 32 | | 30 | | |
| | Resin emulsion 2 | 2 | 3 | | 3 | 30 |
| | Resin emulsion 3 | | 27 | | | |
| | Resin emulsion 4 | | | | 27 | |
| Water | Highly pure water | 30.5 | 32 | 34 | 33 | 20 |
| Surfactant | FS-300 | 6 | 6 | 6 | 6 | 6 |
| Organic | 1,2-Propanediol | 15.5 | 18 | 16 | 17 | 30 |
| solvent | 1,3-Propanediol | 11 | 11 | 11 | 11 | 11 |
| | 1,2-Butanediol | 3 | 3 | 3 | 3 | 3 |

| | | | | | |
|---|---|---|---|---|---|
| Total (% by mass) | 100 | 100 | 100 | 100 | 100 |
| Resin solid component in clear ink (% by mass) | 10.2 | 9 | 9 | 9 | 9 |
| Volume average particle diater of clear ink (nm) | 46 nm | 41 nm | 44 nm | 56 nm | 105 nm |
| MA:MB | 94:6 | — | — | 90:10 | — |
| Tg of dried film of clear ink | 54° C., | 45° C., | 55° C. | 55° C., | −4° C. |
| | −3° C. | −3° C. | | −4° C. | |

### Preparation Example 5

<Preparation of Self-Dispersible Magenta Pigment Dispersion>

A mixture of the following prescription was premixed and subsequently subjected to circulation dispersion for seven hours using a disk-type bead mill (obtained from Shinmaru Enterprises Corporation, KDL type, using zirconia balls having a diameter of 0.3 mm as media), to obtain a self-dispersible magenta pigment dispersion (with a pigment solid component concentration of 15% by mass).

-Pigment red 122 (product name: TONER MAGENTA E002, obtained from Clamant Japan K. K.)---15 parts by mass

-Anionic surfactant (product name: PIONINE A-51-B, obtained from Takemoto Oil & Fat Co., Ltd.)---2 parts by mass

-Ion-exchanged water---83 parts by mass

### Production Example 11

-Production of magenta ink A-

The resin emulsion 1 of Preparation example 1 (with a solid component concentration of 30% by mass) (25% by mass), the self-dispersible magenta pigment dispersion (with a solid component concentration of 15% by mass) (20% by mass), 1,2-propanediol (20% by mass), 1,3-propanediol (11% by mass), 1,2-butanediol (3% by mass), a surfactant “FS-300” (product name) (obtained from Du Pont K. K., a flurosurfactant, with a solid component concentration of 40% by mass) (6% by mass), and highly pure water (15% by mass) were added together and mixed and stirred, to prepare a mixture.

Next, the obtained mixture was filtrated through a polypropylene filter having an average pore diameter of 0.2 micrometers (product name: BETAFINE POLYPROPYLENE PLEATED FILTER PPG SERIES, obtained from 3M Limited), to produce a magenta ink A.

### Example 1

<Inkjet Printing>

The clear ink A of Production example 1 was filled in an ink cartridge of an inkjet printer GXE5500 remodeled apparatus (obtained from Ricoh Company, Ltd.), and the ink cartridge filled with the ink was attached in the inkjet printer GXE5500 remodeled apparatus, to perform inkjet printing.

The image was formed at an image resolution of 600 dpi×600 dpi as a fully solid image having a printing ratio of 100%.

The inkjet printer GXE5500 remodeled apparatus was equipped with heaters (temperature adjusting controllers, MTCD type, obtained from Misumi Inc.) in a manner that a recording medium could be heated from the back before, during, and after printing. This would make it possible to print an image over a recording medium heated with heaters before and during printing, and heat and dry the printed matter with a heater after printing.

-Heating Conditions-

As the heating conditions, the heating temperatures of the respective heaters (heating units) disposed at a pre-printing position, an in-printing position, and a post-printing position were set to 40 degrees C., 40 degrees C., and 60 degrees C.

-Recording Medium-

Digital print wallpaper PROW400F obtained from Lintec Sign System, Inc. was used as a recording medium. The magenta ink A was previously printed over the recording medium, and then the clear ink A was printed. The same printing apparatus as would be used to print the clear ink was used to print the magenta ink A. The heating temperatures of the heaters disposed at a pre-printing position, an in-printing position, and a post-printing position were set to 40 degrees C., 40 degrees C., and 60 degrees C., and only the magenta ink was printed over the recording medium. Images printed with the magenta ink were all printed at an image resolution of 600 dpi×600 dpi as fully solid images having a printing ratio of 100%.

Again using the inkjet printer described above, the clear ink was printed over the recording medium over which the magenta ink coating film was printed.

<Scratch Resistance Test>

The recording medium was set in a Gakushin-Type abrasion tester (a friction tester type II) (instrument name: DYE FRICTION FASTNESS TESTER AR-2(BC), obtained from Intec Co., Ltd.), and scratched in a go-and-return manner 100 times, 250 times, and 500 times with a friction tool (with a load of 200 g) of which contact portion was equipped with white cotton fabric (compliant with JIS L 0803, standard adjacent fabric for dyed color fastness test, shirting No. 3). The coating film after the test was visually observed and rated. The result is presented in Table 2-1. The ratings 3 or higher in the test of 100 times of go-and-return are pass levels.

<Evaluation Criteria>

Rating 5: No scratch marks were observed on the printed surface, and no ink color transfer to the white cotton fabric was observed.

Rating 4: No scratch marks were observed on the printed surface, but a slight ink color transfer to the white cotton fabric was observed.

Rating 3: When observed from a close position, color change and gloss change were observed on the scratched portion, and a slight ink color transfer to the white cotton fabric was observed.

Rating 2: When observed from a distant position, color change and gloss change were observed on the scratched portion, or an apparent ink color transfer to the white cotton fabric was observed.

Rating 1: The background of the recording medium was partially exposed.

### Examples 2 to 6

Inkjet printing was performed in the same manner as in Example 1, except that unlike in Example 1, the clear ink A was changed to the clear inks B to F, and scratch resistance test was performed in the same manner as in Example 1. The results are presented in Table 2-1.

### Comparative Examples 1 to 4

Inkjet printing was performed in the same manner as in Example 1, except that unlike in Example 1, the clear ink A was changed to the clear inks G to J, and scratch resistance test was performed in the same manner as in Example 1. The results are presented in Table 2-2.

Comparative Example 4 was very unsuccessful in the test of 100 times of goand-return (Rating 1), and was suspended from the test of 250 times of go-and-return and 500 times of go-and-return.

### Comparative Example 5

Scratch resistance test was performed in the same manner as in Example 1, except that unlike in Example 1, a recording medium over which the clear ink A was not printed and only the magenta ink A was printed was used. The result is presented in Table 2-2.

Comparative Example 5 was very unsuccessful in the test of 100 times of goand-return (Rating 1), and was suspended from the test of 250 times of go-and-return and 500 times of go-and-return.

TABLE 2-1

| | | Ex. 1 | Ex. 2 | Ex. 3 | Ex. 4 | Ex. 5 | Ex. 6 |
|---|---|---|---|---|---|---|---|
| Clear ink | | A | B | C | D | E | F |
| Scratch | after 100 times | Rating 5 | Rating 5 | Rating 5 | Rating 5 | Rating 5 | Rating 5 |
| resistance | of go-and-return | | | | | | |
| test rating | after 250 times | Rating 4 | Rating 4 | Rating 4 | Rating 4 | Rating 3 | Rating 5 |
| | of go-and-return | | | | | | |
| | after 500 times | Rating 2 | Rating 3 | Rating 3 | Rating 3 | Rating 2 | Rating 4 |
| | of go-and-return | | | | | | |

TABLE 2-2

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Clear ink | | G | H | I | J | Absent |
| Scratch | after 100 times | Rating 2 | Rating 2 | Rating 2 | Rating 1 | Rating 1 |
| resistance | of go-and-return | | | | | |
| test rating | after 250 times | Rating 2 | Rating 2 | Rating 2 | Evaluation | Evaluation |
| | of go-and-return | | | | suspended | suspended |
| | after 500 times | Rating 1 | Rating 1 | Rating 1 | Evaluation | Evaluation |
| | of go-and-return | | | | suspended | suspended |

Comparing “Examples 1 to 6” with “Comparative Examples 1 to 4”, “Examples 1 to 6” in which clear inks having a resin particle volume average particle diameter of 50 nm or less was printed and dried films of the clear inks had glass transition temperatures (Tg) at 50 degrees C. or higher and at lower than 0 degrees C. achieved the ratings 3 or higher in the scratch resistance test of 100 times of go-and-return, and exhibited a good scratch resistance.

Comparing “Example 1 and Example 5” with “Examples 2, 3, 4, and 6”, clear inks having a mass ratio MA:MB of from 98:2 through 80:20 between the mass MA of resin particles A having Tg at 50 degrees C. or higher and the mass MB of resin particles B having Tg at lower than 0 degrees C. exhibited a good scratch resistance also after 250 times of go-and-return and 500 times of go-and-return.

### Example 7

A re-remodeled apparatus of the same GXE5500 remodeled apparatus as used in Example 1 was prepared by replacement of, for example, the internal head in a manner that the circulation mechanism illustrated in FIG. 3 to FIG. 14 was installed, and inkjet printing was performed. Hereinafter, the re-remodeled apparatus will be referred to as “circulation mechanism-added apparatus.

Next, discharging stability, long-term discharging stability, and nozzle recoverability were evaluated in the manners described below. The results are presented in Table 3-1.

<Short-Term Discharging Stability>

At a temperature of 32 degrees C.±0.5 degrees C. at 30±5% RH and under the same heating conditions and with the same recording medium as in Example 1, a magenta ink coating film was previously printed and a clear ink coating film was printed thereon in the same manner as in Example. Presence or absence of streak, void, and discharging disorder on the clear image of the obtained printed matter was visually observed and evaluated. The evaluation criteria are as described below. The ratings AA and A are pass levels, and the ratings B and C are failure levels.

<Evaluation Criteria>

AA: No streak, void, and discharging disorder were observed at all on the solid portion.

A: Streak, void, and discharging disorder were observed at two positions or less on the solid portion.

B: Streak, void, and discharging disorder were observed at three positions or more on the solid portion.

C: The ink was not discharged, thus failing to form an image.

<Long-Term Discharging Stability>

At a temperature of 32 degrees C.±0.5 degrees C. at 30±5% RH and under the same heating conditions and with the same recording medium as in Example 1, a fully solid image of a clear ink coating film was printed continuously for 15 minutes. Immediately subsequently, without a cleaning operation of the head, a magenta ink coating film was printed and a clear ink coating film was printed thereon in the same manner as in Example 1. Presence or absence of streak, void, and discharging disorder on the clear image of the obtained printed matter was visually observed and evaluated. The evaluation criteria are the same as short-term discharging stability. The ratings AA and A are pass levels, and the ratings B and C are failure levels.

<Nozzle Recoverability>

At a temperature of 32 degrees C.±0.5 degrees C. at 15±5% RH, the head was left to stand in a decapped state for 24 hours, and subsequently a cleaning operation was repeated three times. Subsequently, a nozzle check pattern was printed over synthetic paper VJFN160 (white color polypropylene film) obtained from Yupo Corporation, to visually observe and evaluate whether each nozzle succeeded in discharging an ink. The evaluation criteria are as described below. The rating A is a pass level, and the ratings B to D are failure levels.

<Evaluation Criteria>

A: All nozzles succeeded in discharging an ink normally.

B: Half or less of all nozzles failed in discharging an ink.

C: Half of more of all nozzles failed in discharging an ink.

D: No ink was discharged at all.

### Examples 8 to 12

Inkjet printing was performed in Examples 8 to 12 in the same manner as in Example 7, except that unlike in Example 7, the clear ink A was changed to the clear inks B to F, to evaluate discharging stability, long-term discharging stability, and nozzle recoverability. The results are presented in Tables 3-1 and 3-2.

### Comparative Examples 6 to 11

Inkjet printing was performed in Comparative Examples 6 to 11 in the same manner as in Example 7, except that unlike in Example 7, the printing apparatus was changed to the GXE-5500 remodeled apparatus in which no circulation mechanism was incorporated (the same as in Example 1), to evaluate discharging stability, long-term discharging stability, and nozzle recoverability. The results are presented in Tables 4-1 and 4-2.

TABLE 3-1

| | Ex. 7 | Ex. 8 | Ex. 9 |
|---|---|---|---|
| Clear ink | A | B | C |
| Presence or absence of | Present | Present | Present |
| circulation mechanism | | | |
| Short-term discharging stability | AA | AA | AA |
| Long-term discharging stability | AA | AA | AA |
| Nozzle recoverability | A | A | A |

TABLE 3-2

| | Ex. 10 | Ex. 11 | Ex. 12 |
|---|---|---|---|
| Clear ink | D | E | F |
| Presence or absence of | Present | Present | Present |
| circulation mechanism | | | |
| Short-term discharging stability | AA | AA | AA |
| Long-term discharging stability | A | AA | A |
| Nozzle recoverability | A | A | A |

TABLE 4-1

| | Comp. Ex. 6 | Comp. Ex. 7 | Comp. Ex. 8 |
|---|---|---|---|
| Clear ink | A | B | C |
| Presence or absence of | Absent | Absent | Absent |
| circulation mechanism | | | |
| Short-term discharging stability | A | A | A |
| Long-term discharging stability | B | B | B |
| Nozzle recoverability | C | C | C |

TABLE 4-2

| | Comp. Ex. 9 | Comp. Ex. 10 | Comp. Ex. 11 |
|---|---|---|---|
| Clear ink | D | E | F |
| Presence or absence of | Absent | Absent | Absent |
| circulation mechanism | | | |
| Short-term discharging stability | A | A | A |
| Long-term discharging stability | C | B | G |
| Nozzle recoverability | C | C | D |

From the results of Tables 3-1 and 3-2 and Tables 4-1 and 4-2, when comparing Examples 7 to 12 with Comparative Examples 6 to 11, it was revealed that discharging stability was improved when the head was provided with the circulation mechanism. Particularly, this effect is remarkable when discharging was performed continuously for a long term.

As regards nozzle recoverability, when comparing Example 7 to 12 with Comparative Examples 6 to 11, it was revealed that when the head was provided with the circulation mechanism, ink thickening was suppressed even under a highly dry decapped state and nozzles were completely recovered through the subsequent cleaning operation.

Aspects of the Present Disclosure are, for Example, as Follows.

<1>A clear ink including:

resin particles; and

water,

wherein a volume average particle diameter of the resin particles is 50 nm or less, and

wherein a dried film of the clear ink has glass transition temperatures (Tg) at 50 degrees C. or higher and at lower than 0 degrees C.

<2> the Clear Ink According to <1>,

wherein the resin particles contain resin particles A and resin particles B; and

wherein Tg of the resin particles A is 50 degrees C. or higher and Tg of the resin particles B is lower than 0 degrees C.

<3> the Clear Ink According to <2>,

wherein a mass ratio MA:MB between a mass MA of the resin particles A and a mass MB of the resin particles B is from 98:2 through 80:20.

<4> The clear ink according to any one of <1> to <3>, wherein a total content of the resin particles contained in the clear ink is 10% by mass or greater.

<5> The clear ink according to any one of <2> to <4>, wherein the resin particles A are a urethane resin.

<6>A printing method including:

applying an ink containing a colorant; and

applying a clear ink,

wherein the clear ink is the clear ink according to any one of <1> to <5>.

<7> An inkjet printing apparatus including

a discharging unit configured to discharge an ink,

wherein the inkjet printing apparatus includes the clear ink according to any one of

<1> to <5>.

<8> The inkjet printing apparatus according to <7>, further including:

a liquid container configured to contain the clear ink;

a discharging head configured to discharge the clear ink to a print target; and

a heating unit configured to heat the print target,

wherein the discharging head includes an individual liquid chamber leading to a nozzle through which the clear ink is discharged, a flow-in flow path configured to flow the clear ink into the individual liquid chamber, and a flow-out flow path configured to flow the clear ink out from the individual liquid chamber,

wherein the clear ink is circulated through the flow-in flow path and the flow-out flow path.

<9> The inkjet printing apparatus according to <7> or <8>, wherein a content of the resin particles in the clear ink is 8% by mass or greater.

<10> The inkjet printing apparatus according to any one of <7> to <9>, wherein the clear ink contains a surfactant, and

wherein a content of the surfactant in the clear ink is 2% by mass or less.

The clear ink according to any one of <1> to <5>, the printing method according to

<6>, and the inkjet printing apparatus according to any one of <7> to <10>can solve the various problems in the related art and achieve the object of the present disclosure.

### REFERENCE SIGNS LIST

400: image forming apparatus
401: exterior of image forming apparatus
401c: cover of main body
404: cartridge holder
410: main tank
410k, 410c, 410m, 410y: main tanks for black (K), cyan (C), magenta (M), and yellow (Y)
411: ink accommodating unit
413: ink discharging outlet
414: housing unit
420: mechanical unit
434: discharging head
436: supplying tube

1. A clear ink, comprising:
resin particles; and
water,
wherein a volume average particle diameter of the resin particles is 50 nm or less, and
wherein a dried film of the clear ink has glass transition temperatures (Tg) at 50 degrees C. or higher and at lower than 0 degrees C.

2. The clear ink according to claim 1, wherein the resin particles comprise resin particles A and resin particles B; and
wherein Tg of the resin particles A is 50 degrees C. or higher and Tg of the resin particles B is lower than 0 degrees C.

3. The clear ink according to claim 2, wherein a mass ratio MA:MB between a mass MA of the resin particles A and a mass MB of the resin particles B is from 98:2 through 80:20.

4. The clear ink according to claim 1, wherein a total content of the resin particles contained in the clear ink is 10% by mass or greater.

5. The clear ink according to claim 2, wherein the resin particles A comprise a urethane resin.

6. A printing method, comprising:
applying an ink containing a colorant, and
applying a clear ink,
wherein the clear ink is the clear ink according to claim 1.

7. An inkjet printing apparatus, comprising:
a discharging unit configured to discharge an ink,
wherein the inkjet printing apparatus comprises the clear ink according to claim 1.

8. The inkjet printing apparatus according to claim 7, further comprising:
a liquid container configured to contain the clear ink;
a discharging head configured to discharge the clear ink to a print target; and
a heating unit configured to heat the print target,
wherein the discharging head comprises an individual liquid chamber leading to a nozzle through which the clear ink is discharged, a flow-in flow path configured to flow the clear ink into the individual liquid chamber, and a flow-out flow path configured to flow the clear ink out from the individual liquid chamber,
wherein the clear ink is circulated through the flow-in flow path and the flow-out flow path.

9. The inkjet printing apparatus according to claim 7, wherein a content of the resin particles in the clear ink is 8% by mass or greater.

10. The inkjet printing apparatus according to claim 7, wherein the clear ink contains a surfactant, and
wherein a content of the surfactant in the clear ink is 2% by mass or less.
